(19) United States
(12) Patent Application Publication
(10) Pub. No.: US 2026/0287856 A1
(43) Pub. Date: Sep. 24, 2026

(54) OPTICAL SYSTEM, IMAGE MODULE, AND ELECTRONIC DEVICE

(71) Applicant: Jiangxi OFILM Optical Co., Ltd., Nanchang (CN)

(72) Inventors: LIHUI HUANG, Nanchang (CN); Zikang Zeng, Nanchang (CN)

(21) Appl. No.: 19/288,248

(22) Filed: Aug. 1, 2025

(30) Foreign Application Priority Data
Mar. 19, 2025 (CN) 202510324655.2

(51) Int. Cl. G02B 13/00; G02B 9/62; H04N 23/55

(52) U.S. Cl. CPC G02B 13/0045; G02B 9/62; H04N 23/55

(57) ABSTRACT

An optical system includes: a first lens, a fourth lens and a sixth lens each having negative refractive power, a second lens, a third lens and a fifth lens each having positive refractive power, and an image plane. Near the optical axis, an imaging side surface of the first lens, an object side surface and an imaging side surface of the second lens, an object side surface and an imaging side surface of the third lens, an object side surface and an imaging side surface of the fifth lens are both convex, an object side surface of the first lens, an object side surface and an imaging side surface of the fourth lens, and an object side surface of the sixth lens are both concave. The optical system satisfies: 30deg<FOV<45deg, and 5.2<TTL/IMGH<6.8. An image module and an electronic device are also provided.

### FIELD

The present disclosure relates to field of imaging, and in particular to an optical system, an image module, and an electronic device.

### BACKGROUND

With the rapid development of automotive assisted driving systems in recent years, optical lenses have been widely applied in automobiles. For example, optical lenses can be widely used in vehicle rearview camera systems, dash cameras, automatic parking and panoramic parking systems, road navigation systems, etc.

Vehicle-mounted optical lenses are key components for automotive assisted driving systems to obtain external information. For safety considerations, the performance requirements for vehicle-mounted lenses are very strict. Firstly, it is required that the vehicle-mounted lens has a high imaging clarity, which can effectively distinguish the details of the road environment. It is also required that the vehicle-mounted lens has a large field of view to better collect the road information in front of the vehicle to meet the special requirements of the intelligent driving system. In addition, due to the limited installation space of the vehicle-mounted system, the volume of the lens used in the vehicle is not allowed to be too large.

### SUMMARY

The purpose of the present application is to provide an optical system, an image module and an electronic device, to solve the problem that the vehicle-mounted optical system needs to be miniaturized, have a relatively high imaging clarity and a relatively large field of view.

In order to achieve the above objects, in a first aspect, the present application discloses an optical system. The optical system sequentially includes a first lens, a second lens, a third lens, a fourth lens, a fifth lens, a sixth lens, and an image plane along an optical axis from an object side to an imaging side. The first lens has negative refractive power, an object side surface of the first lens is concave near the optical axis, and an imaging side surface of the first lens is convex near the optical axis. The second lens has positive refractive power, an object side surface of the second lens is convex near the optical axis, and an imaging side surface of the second lens is convex near the optical axis. The third lens has positive refractive power, an object side surface of the third lens is convex near the optical axis, and an imaging side surface of the third lens is convex near the optical axis. The fourth lens has negative refractive power, an object side surface of the fourth lens is concave near the optical axis, an imaging side surface of the fourth lens is concave near the optical axis. The fifth lens has positive refractive power, an object side surface of the fifth lens is convex near the optical axis, and an imaging side surface of the fifth lens is convex near the optical axis. The sixth lens has negative refractive power, an object side surface of the sixth lens is concave near the optical axis.

The optical system satisfies following conditional expressions: 30deg<FOV<45deg, and 5.2<TTL/IMGH<6.8. Wherein, FOV is the maximum field of view angle of the optical system, TTL is a distance from the object side surface of the first lens to the image plane of the optical system along the optical axis, and IMGH is half of an image height corresponding to the maximum field of view angle of the optical system.

By arranging the first lens to have negative refractive power, with an object side surface of the first lens being concave near the optical axis and an imaging side surface of the first lens being convex near the optical axis, it is beneficial for the light to enter gently, thereby preventing the light from being bent too much, effectively reducing the field curvature and astigmatism of the optical system, and lowering the overall sensitivity of the optical system. By arranging the second lens to have positive refractive power, with an object side surface of the second lens being convex near the optical axis and an imaging side surface of the second lens being convex near the optical axis, it is conducive to initially correcting the astigmatism of the optical system and effectively controlling the light path, thereby achieving a larger aperture. By arranging the third lens to have positive refractive power, with an object side surface of the third lens being convex near the optical axis, and an imaging side surface of the third lens being convex near the optical axis, it is conducive to enhancing the positive refractive power of the third lens and further providing a reasonable incident angle for the edge rays. By arranging the fourth lens to have negative refractive power, with an object side surface of the fourth lens being concave near the optical axis and an imaging side surface of the fourth lens being concave near the optical axis, it is beneficial for the edge rays to enter and deflect, thereby reducing the deflection angle that the subsequent lenses need to bear, and allowing the deflection angles of the rays on each lens to be more uniform, so that the aberrations in the edge field of view can be effectively corrected. The third lens and the fourth lens are cemented lenses, which helps to correct chromatic aberration and balance various aberrations to improve the resolution of the optical system, and which can effectively reduce the sensitivity to tolerances to enhance the imaging quality of the optical system. By arranging the fifth lens to have positive refractive power, with both the object side surface and the imaging side surface of the fifth lens being convex near the optical axis, it is beneficial for effectively collecting and compressing the incident rays on the object side of the fifth lens, thereby allowing the rays to gently transition to the optical system on the imaging side of the fifth lens. By arranging the sixth lens to have negative refractive power, with the object side surface of the sixth lens being concave near the optical axis and the imaging side surface of the sixth lens being concave, convex or planar near the optical axis, it is beneficial for lowering the incident angle of the rays after passing through an aperture, thereby allowing more rays to enter the optical system on the imaging side and improving the illuminance of the optical system.

By arranging the optical system to satisfy the conditional expression: 30deg≤FOV≤45deg, the maximum field of view angle of the optical system is controlled within a reasonable range, thereby avoiding the introduction of excessive aberrations, and allowing the optical system to achieve a sufficient field of view while meeting the characteristics of miniaturization.

By arranging the optical system to satisfy the conditional expression: 5.2<TTL/IMGH<6.8, a ratio of a total length of the optical system to the image height is reasonably configured, combined with the above range of the maximum field of view angle of the optical system, it is beneficial to limit the total length of the optical system and achieve the miniaturization of the optical system.

In some embodiments, the optical system satisfies following conditional expression: 18deg≤FOV/FNO≤27deg. By arranging the optical system to satisfy the above conditional expression, a ratio of the field of view angle to the aperture number of the optical system is reasonably configured, thereby achieving the combined effect of a large field of view angle and a large aperture in the optical system. The optical system has a reasonable amount of light intake to enhance the overall illuminance of the imaging picture, so that the optical system can be suitable for different lighting environments.

In some embodiments, the optical system satisfies following conditional expression: 1.6≤FNO≤1.8. By arranging the optical system to satisfy the above conditional expression, the aperture number of the optical system is set within a reasonable range, thereby achieving the combined effect of a large field of view angle and a large aperture in the optical system. The optical system has a reasonable amount of light intake to enhance the overall illuminance of the imaging picture, so that the optical system can be suitable for different lighting environments.

In some embodiments, the optical system satisfies following conditional expression: 7.9 mm≤TTL×IMGH/F≤11 mm. Wherein, F is an effective focal length of the optical system. By arranging the optical system to satisfy the above conditional expression, the optical system can be adapted to a large image plane, which is conducive to the optical system simultaneously meeting the requirements of miniaturization and large target surface performance.

In some embodiments, the optical system satisfies following conditional expression: 0.19≤(CT3+CT4)/TTL≤0.35. Wherein, CT3 is a thickness of the third lens at the optical axis, and CT4 is a thickness of the fourth lens at the optical axis. By arranging the optical system to satisfy the above conditional expression, a center thickness of the cemented lens composed of the third lens and the fourth lens is reasonably configured, which is conducive to enhancing the light control ability of the third lens and the fourth lens, thereby facilitating more light to enter the optical system behind the fourth lens and improving the relative illuminance of the optical system.

In some embodiments, the optical system satisfies following conditional expression: 3≤(CT2+CT3)/CT23≤55. Wherein, CT2 is a thickness of the second lens at the optical axis, and CT23 is a distance from the imaging side surface of the second lens to the object side surface of the third lens at the optical axis. By arranging the optical system to satisfy the above conditional expression, the thickness of the second lens at the optical axis and the thickness of the third lens at the optical axis are reasonably set, which is conducive to simplifying the surface shape settings of the second lens and the third lens, thereby allowing the second lens and the third lens to adjust each other and reducing aberrations, at the same time, the distance between the second lens and the third lens at the optical axis is also reasonably set, which is conducive to controlling the incident angle of light and maintaining the miniaturization feature of the optical system.

In some embodiments, the optical system satisfies following conditional expression: 0.7≤CT3/CT4≤5.1. By arranging the optical system to satisfy the above conditional expression, a ratio of the thickness of the third lens at the optical axis to the thickness of the fourth lens at the optical axis is reasonably configured, and the third lens and the fourth lens can adjust each other, thereby maintaining the miniaturization feature of the optical system.

In some embodiments, the optical system satisfies following conditional expression: 0.85≤SD1/IMGH≤1.3. Wherein, SD1 is half of the maximum effective aperture of the object side surface of the first lens. By arranging the optical system to satisfy the above conditional expression, a ratio of half of the maximum effective aperture of the object side surface of the first lens to half of the image height corresponding to the maximum field of view angle of the optical system is reasonably configured, which is conducive to reasonably controlling the size of the object side surface of the first lens, thereby achieving the miniaturization of the optical system.

In some embodiments, the optical system satisfies following conditional expression: 5.2≤TTL/SDL1≤6.3. Wherein, SDL1 is the larger of half of the maximum effective aperture of the object side surface of the first lens and half of the maximum effective aperture of the imaging side surface of the first lens. By arranging the optical system to satisfy the above conditional expression, a ratio of the total length of the optical system to the larger of half of the maximum effective aperture of the object side surface of the first lens and half of the maximum effective aperture of the imaging side surface of the first lens can be reasonably configured. When the total length of the optical system is constant, the size of the first lens can be reasonably restricted, which is conducive to limiting the head size of the optical system and achieving the miniaturization of the optical system.

In some embodiments, the optical system satisfies following conditional expression: 0.78≤SD9/SD1≤0.97. Wherein, SD9 is half of the maximum effective aperture of the object side surface of the fifth lens. By arranging the optical system to satisfy the above conditional expression, it is beneficial to reasonably configure a ratio of half of the maximum effective aperture of the object side surface of the first lens to half of the maximum effective aperture of the object side surface of the fifth lens, thereby controlling an outer diameter size of the lens group in the optical system to reduce the thickness of the optical system in the radial direction, so that the requirement of miniaturizing the optical system can be achieved.

In some embodiments, the optical system satisfies following conditional expression: 0.9≤F3/F≤1.2. Wherein, F3 is an effective focal length of the third lens, and F is the effective focal length of the optical system. By arranging the optical system to satisfy the above conditional expression, it is beneficial to properly coordinate the refractive power of the third lens in the optical system, allowing the surface shape design of the third lens to be simpler and more flexible, reducing aberrations, and simplifying the balance between the aberration correction and the imaging quality of the overall optical system.

In some embodiments, the optical system satisfies following conditional expression: −10≤F4/CT4≤−1.5. Wherein, F4 is an effective focal length of the fourth lens, and CT4 is the thickness of the fourth lens at the optical axis. By arranging the optical system to satisfy the above conditional expression, it is beneficial to reasonably configure a ratio of the effective focal length of the fourth lens to the thickness of the fourth lens at the optical axis, which is conducive to simplifying the surface shape setting of the fourth lens.

In some embodiments, the optical system satisfies following conditional expression: −1.2≤F/F34≤−0.2. Wherein, F34 is a combined effective focal length of the third lens and the fourth lens. By arranging the optical system to satisfy the above conditional expression, it is beneficial to reasonably configure a ratio of the effective focal length of the optical system to the effective focal length of the cemented lens composed of the third lens and the fourth lens, which is conducive to correcting chromatic aberration and balancing various aberrations, improving the resolution ability of the optical system, effectively reducing the tolerance sensitivity of the optical system, and thereby enhancing the imaging quality of the optical system.

In some embodiments, the optical system satisfies following conditional expression: −1.4 mm⁻¹≤(VD3−VD4)/F34≤−0.35 mm⁻¹. Wherein, VD3 is an Abbe number of the third lens, and VD4 is an Abbe number of the fourth lens. By arranging the optical system to satisfy the above conditional expression, a ratio of a difference between the Abbe number of the third lens and the Abbe number of the four lens to the combined effective focal length of the third lens and the fourth lens is reasonably configured, which is conducive to effectively correcting chromatic aberration in the optical system, restoring the authenticity of the colors during imaging, thereby improving the imaging quality of the optical system.

In some embodiments, the optical system satisfies following conditional expression: 0.67≤CT1/ET1≤0.96. Wherein, CT1 is a thickness of the first lens at the optical axis, and ET1 is an edge thickness of the first lens, that is, a distance along the optical axis from the maximum effective aperture of the object side surface of the first lens to the maximum effective aperture of the imaging side surface of the first lens. By arranging the optical system to satisfy the above conditional expression, a ratio of the thickness of the first lens at the optical axis to the edge thickness of the first lens is reasonably configured, which is conducive to simplifying the production and manufacturing of the first lens.

In some embodiments, the optical system satisfies following conditional expression: 1.15≤CT2/ET2≤1.55. Wherein, CT2 is the thickness of the second lens at the optical axis, and ET2 is an edge thickness of the second lens, that is, a distance along the optical axis from the maximum effective aperture of the object side surface of the second lens to the maximum effective aperture of the imaging side surface of the second lens. By arranging the optical system to satisfy the above conditional expression, a ratio of the thickness of the second lens at the optical axis to the edge thickness of the second lens is reasonably configured, which is conducive to simplifying the production and manufacturing of the second lens.

In some embodiments, the optical system satisfies following conditional expression: −14≤(F1+F2)/F≤−1.5. Wherein, F1 is an effective focal length of the first lens, and F2 is an effective focal length of the second lens. By arranging the optical system to satisfy the above conditional expression, a ratio of the sum of the effective focal lengths of the first lens and the second lens to the effective focal length of the optical system is reasonably configured, which is conducive to mutual correction of the aberrations produced by the first lens and the second lens, and thereby improving the imaging quality of the optical system.

In some embodiments, the optical system satisfies following conditional expression:−2.5≤SAG11/CT6≤−1. Wherein, SAG11 is a vector height at the maximum effective aperture of the object side surface of the sixth lens, that is, a distance between an intersection point of the object side surface of the sixth lens and the optical axis to the maximum effective aperture of the object side surface of the sixth lens in the direction of the optical axis, and CT6 is a thickness of the sixth lens at the optical axis. By arranging the optical system to satisfy the above conditional expression, it is beneficial to reasonably control the refractive power and thickness of the sixth lens at each point in the direction perpendicular to the optical axis, thereby avoiding the sixth lens being too thick or too thin, reducing the incident angle of light on the object side surface of the sixth lens, and reducing the tolerance sensitivity of the optical system.

In some embodiments, the optical system satisfies following conditional expression: 7≤|SAG11/SAG12|≤31. Wherein, SAG12 is a vector height at the maximum effective aperture of the imaging side surface of the sixth lens, that is, a distance between an intersection point of the imaging side surface of the sixth lens and the optical axis to the maximum effective aperture of the imaging side surface of the sixth lens in the direction of the optical axis. By arranging the optical system to satisfy the above conditional expression, it is beneficial to reasonably control the shape of the sixth lens and correct the distortion and the field curvature produced by the object side surface of the sixth lens.

In some embodiments, the optical system satisfies following conditional expression: 0.25≤CT6/ET6≤0.55. Wherein, ET6 is an edge thickness of the sixth lens, that is, a distance along the optical axis from the maximum effective aperture of the object side surface of the sixth lens to the maximum effective aperture of the imaging side surface of the sixth lens. By arranging the optical system to satisfy the above conditional expression, a ratio of the thickness of the sixth lens at the optical axis to the edge thickness of the sixth lens can be reasonably configured, which is beneficial to simplify the production and manufacturing of the sixth lens.

In some embodiments, the optical system satisfies following conditional expression: 1.1≤|(R3−R4)/(R3+R4)|≤6.3. Wherein, R3 is a radius of curvature of the object side surface of the second lens at the optical axis, and R4 is a radius of curvature of the imaging side surface of the second lens at the optical axis. By arranging the optical system to satisfy the above conditional expression, it is beneficial to control the shape of the second lens, comprehensively balance the spherical aberration, the chromatic aberration and the field curvature of the optical system, and reduce the risk of ghosting, thereby improving the resolution of the optical system.

In some embodiments, the optical system satisfies following conditional expression: 8≤|R12/R11|<31. Wherein, R11 is a radius of curvature of the object side surface of the sixth lens at the optical axis, and R12 is a radius of curvature of the imaging side surface of the sixth lens at the optical axis. By arranging the optical system to satisfy the above conditional expression, it is beneficial to reasonably configure a ratio of the radius of curvature of the object side surface of the sixth lens at the optical axis to the radius of curvature of the imaging side surface of the sixth lens at the optical axis, control the shape of the sixth lens, comprehensively balance the spherical aberration, the chromatic aberration and the field curvature of the optical system, reduce the risk of ghosting, improve the resolution of the optical system, and at the same time, it is also beneficial to reduce the processing difficulty of the sixth lens.

In some embodiments, the optical system satisfies following conditional expression: 4.5≤|R12/F|≤19. By arranging the optical system to satisfy the above conditional expression, it is beneficial to reasonably configure a ratio of the radius of curvature of the imaging side surface of the sixth lens to the effective focal length of the optical system, which can increase the image height of the optical system under the condition that the field of view angle remains unchanged, thereby allowing the optical system to receive light at a larger angle, reducing the distortion of the optical system, and at the same time, the turning angle of the light when reaching the sixth lens can be smaller, which is beneficial to reduce the tolerance sensitivity of the optical system.

In a second aspect, the present application discloses an image module. The image module includes a photosensitive chip and the optical system of any one embodiment in the first aspect, the photosensitive chip is arranged on the imaging side of the optical system. A photosensitive surface of the photosensitive chip is located on the image plane of the optical system, and the light from the object passing through the lenses and transmitted to the photosensitive surface can be converted into an electrical signal of the image. The photosensitive chip may be a complementary metal oxide semiconductor (CMOS) or a charge-coupled device (CCD). The image module may be an imaging module integrated in an electronic device or an independent lens. By incorporating the optical system provided by the present disclosure into the image module, the image module can have the characteristics of miniaturization, high imaging clarity and large field of view angle through reasonable design of the surface shape and refractive power of each lens in the optical system.

In a third aspect, the present application discloses an electronic device. The electronic device includes a housing and the image module in the second aspect, the image module is arranged in the housing. The electronic device can be, but is not limited to, an automobile, a monitoring device, a smart phone, a computer and a smart watch, etc. By incorporating the image module provided by the present disclosure into the electronic device, the electronic device can have the characteristics of miniaturization, high imaging clarity and large field of view angle.

### BRIEF DESCRIPTION OF THE DRAWINGS

To better describe and illustrate embodiments and/or examples of those inventions disclosed herein, reference may be made to one or more of the accompanying drawings. The additional details or examples used to describe the drawings should not be construed as limiting the scope of any of the disclosed inventions, the embodiments and/or examples presently described, and the best modes currently understood of these inventions.

FIG. 1 is a schematic structure diagram of an optical system of a first embodiment of the present application.

FIG. 2 is a longitudinal spherical aberration diagram, astigmatism curve diagram and distortion diagram of the optical system of the first embodiment of the present application.

FIG. 3 is a schematic structure diagram of an optical system of a second embodiment of the present application.

FIG. 4 is a longitudinal spherical aberration diagram, astigmatism curve diagram and distortion diagram of the optical system of the second embodiment of the present application.

FIG. 5 is a schematic structure diagram of an optical system of a third embodiment of the present application.

FIG. 6 is a longitudinal spherical aberration diagram, astigmatism curve diagram and distortion diagram of the optical system of the third embodiment of the present application.

FIG. 7 is a schematic structure diagram of an optical system of a fourth embodiment of the present application.

FIG. 8 is a longitudinal spherical aberration diagram, astigmatism curve diagram and distortion diagram of the optical system of the fourth embodiment of the present application.

FIG. 9 is a schematic structure diagram of an optical system of a fifth embodiment of the present application.

FIG. 10 is a longitudinal spherical aberration diagram, astigmatism curve diagram and distortion diagram of the optical system of the fifth embodiment of the present application.

FIG. 11 is a schematic diagram of an image module of an embodiment of the present application.

FIG. 12 is a schematic diagram of an electronic device of an embodiment of the present application.

### DETAILED DESCRIPTION

The following will describe the technical solutions of the embodiments of the present disclosure clearly and completely in combination with the accompanying drawings of the embodiments of the present disclosure. Obviously, the described embodiments are only part of the embodiments of the present disclosure, not all of them. Based on the embodiments of the present disclosure, those skilled in the art can make various modifications or variations without departing from the spirit or scope of the present disclosure. All other embodiments obtained by persons of ordinary skill in the art without making creative efforts fall within the scope of protection of the present disclosure.

In some embodiments, the present application provides an optical system sequentially includes a first lens, a second lens, a third lens, a fourth lens, a fifth lens, and a sixth lens along an optical axis from an object side to an imaging side. The first lens has negative refractive power, an object side surface of the first lens is concave near the optical axis, and an imaging side surface of the first lens is convex near the optical axis. The second lens has positive refractive power, an object side surface of the second lens is convex near the optical axis, and an imaging side surface of the second lens is convex near the optical axis. The third lens has positive refractive power, an object side surface of the third lens is convex near the optical axis, and an imaging side surface of the third lens is convex near the optical axis. The fourth lens has negative refractive power, an object side surface of the fourth lens is concave near the optical axis, and an imaging side surface of the fourth lens is concave near the optical axis. The fifth lens has positive refractive power, an object side surface of the fifth lens is convex near the optical axis, and an imaging side surface of the fifth lens is convex near the optical axis. The sixth lens has negative refractive power, an object side surface of the sixth lens is concave near the optical axis, and an imaging side surface of the sixth lens is convex, concave or planar near the optical axis.

The optical system satisfies following conditional expressions: 30deg<FOV<45deg, and 5.2<TTL/IMGH<6.8. Wherein, FOV is the maximum field of view angle of the optical system, TTL is a distance from the object side surface of the first lens to the image plane of the optical system along the optical axis, and IMGH is half of an image height corresponding to the maximum field of view angle of the optical system. For example, FOV may be 40deg, 30deg, 45deg, 32deg, 38deg, 42deg, 43deg, 31deg, 35deg, etc. TTL/IMGH may be 5.208, 5.359, 6.586, 6.754, 5.873, 5.213, 6.792, 6.037, etc.

By arranging the first lens to have negative refractive power, with an object side surface of the first lens being concave near the optical axis and an imaging side surface of the first lens being convex near the optical axis, it is beneficial for the light to enter gently, thereby preventing the light from being bent too much, effectively reducing the field curvature and astigmatism of the optical system, and lowering the overall sensitivity of the optical system. By arranging the second lens to have positive refractive power, with an object side surface of the second lens being convex near the optical axis and an imaging side surface of the second lens being convex near the optical axis, it is conducive to initially correcting the astigmatism of the optical system and effectively controlling the light path, thereby achieving a larger aperture. By arranging the third lens to have positive refractive power, with an object side surface of the third lens being convex near the optical axis, and an imaging side surface of the third lens being convex near the optical axis, it is conducive to enhancing the positive refractive power of the third lens and further providing a reasonable incident angle for the edge rays. By arranging the fourth lens to have negative refractive power, with an object side surface of the fourth lens being concave near the optical axis and an imaging side surface of the fourth lens being concave near the optical axis, it is beneficial for the edge rays to enter and deflect, thereby reducing the deflection angle that the subsequent lenses need to bear, and allowing the deflection angles of the rays on each lens to be more uniform, so that the aberrations in the edge field of view can be effectively corrected. The third lens and the fourth lens are cemented lenses, which helps to correct chromatic aberration and balance various aberrations to improve the resolution of the optical system, and which can effectively reduce the sensitivity to tolerances to enhance the imaging quality of the optical system. By arranging the fifth lens to have positive refractive power, with both the object side surface and the imaging side surface of the fifth lens being convex near the optical axis, it is beneficial for effectively collecting and compressing the incident rays on the object side of the fifth lens, thereby allowing the rays to gently transition to the optical system on the imaging side of the fifth lens. By arranging the sixth lens to have negative refractive power, with the object side surface of the sixth lens being concave near the optical axis and the imaging side surface of the sixth lens being concave, convex or planar near the optical axis, it is beneficial for lowering the incident angle of the rays after passing through an aperture, thereby allowing more rays to enter the optical system on the imaging side and improving the illuminance of the optical system.

By arranging the optical system to satisfy the conditional expression: 30deg≤FOV≤45deg, the maximum field of view angle of the optical system is controlled within a reasonable range, thereby avoiding the introduction of excessive aberrations, and allowing the optical system to achieve a sufficient field of view while meeting the characteristics of miniaturization.

By arranging the optical system to satisfy the conditional expression: 5.2<TTL/IMGH<6.8, a ratio of a total length of the optical system to the image height is reasonably configured, combined with the above range of the maximum field of view angle of the optical system, it is beneficial to limit the total length of the optical system and achieve the miniaturization of the optical system.

In some embodiments, the optical system may satisfy the following conditional expression: 18deg≤FOV/FNO≤27deg. Wherein, FNO is an aperture number of the optical system. For example, FOV/FNO may be 22.346deg, 23.669deg, 18.293deg, 18.634deg, 26.012deg, 20.823deg, 26.941deg, 24.276deg, etc. By arranging the optical system to satisfy the above conditional expression, a ratio of the field of view angle to the aperture number of the optical system is reasonably configured, thereby achieving the combined effect of a large field of view angle and a large aperture in the optical system. The optical system has a reasonable amount of light intake to enhance the overall illuminance of the imaging picture, so that the optical system can be suitable for different lighting environments.

In some embodiments, the optical system may satisfy the following conditional expression: 1.6≤FNO≤1.8. For example, FNO may be 1.790, 1.690, 1.640, 1.610, 1.730, 1.620, 1.750, 1.770, etc. By arranging the optical system to satisfy the above conditional expression, the aperture number of the optical system is set within a reasonable range, thereby achieving the combined effect of a large field of view angle and a large aperture in the optical system. The optical system has a reasonable amount of light intake to enhance the overall illuminance of the imaging picture, so that the optical system can be suitable for different lighting environments.

In some embodiments, the optical system may satisfy the following conditional expression: 7.9 mm≤TTL×IMGH/F<11 mm. Wherein, F is an effective focal length of the optical system. For example, TTL×IMGH/F may be 9.363 mm, 8.891 mm, 7.996 mm, 8.056 mm, 10.513 mm, 7.910 mm, 9.925 mm, 10.802 mm, etc. By arranging the optical system to satisfy the above conditional expression, the optical system can be adapted to a large image plane, which is conducive to the optical system simultaneously meeting the requirements of miniaturization and large target surface performance.

In some embodiments, the optical system may satisfy the following conditional expression: 0.19≤(CT3+CT4)/TTL≤0.35. Wherein, CT3 is a thickness of the third lens at the optical axis, and CT4 is a thickness of the fourth lens at the optical axis. For example, (CT3+CT4)/TTL may be 0.252, 0.195, 0.334, 0.240, 0.301, 0.205, 0.348, 0.295, etc. By arranging the optical system to satisfy the above conditional expression, a center thickness of the cemented lens composed of the third lens and the fourth lens is reasonably configured, which is conducive to enhancing the light control ability of the third lens and the fourth lens, thereby facilitating more light to enter the optical system behind the fourth lens and improving the relative illuminance of the optical system.

In some embodiments, the optical system may satisfy the following conditional expression: 3≤(CT2+CT3)/CT23≤55. Wherein, CT2 is a thickness of the second lens at the optical axis, and CT23 is a distance from the imaging side surface of the second lens to the object side surface of the third lens at the optical axis. For example, (CT2+CT3)/CT23 may be 31.268, 54.449, 5.769, 3.076, 33.850, 24.052, 44.295, 18.812, etc. By arranging the optical system to satisfy the above conditional expression, the thickness of the second lens at the optical axis and the thickness of the third lens at the optical axis are reasonably set, which is conducive to simplifying the surface shape settings of the second lens and the third lens, thereby allowing the second lens and the third lens to adjust each other and reducing aberrations, at the same time, the distance between the second lens and the third lens at the optical axis is also reasonably set, which is conducive to controlling the incident angle of light and maintaining the miniaturization feature of the optical system.

In some embodiments, the optical system may satisfy the following conditional expression: 0.7≤CT3/CT4≤5.1. For example, CT3/CT4 may be 5.058, 3.900, 0.890, 1.566, 0.707, 2.622, 4.662, 0.962, etc. By arranging the optical system to satisfy the above conditional expression, a ratio of the thickness of the third lens at the optical axis to the thickness of the fourth lens at the optical axis is reasonably configured, and the third lens and the fourth lens can adjust each other, thereby maintaining the miniaturization feature of the optical system.

In some embodiments, the optical system may satisfy the following conditional expression: 0.85≤SD1/IMGH≤1.3. Wherein, SD1 is half of the maximum effective aperture of the object side surface of the first lens. For example, SD1/IMGH may be 0.943, 0.889, 1.222, 1.255, 0.945, 0.852, 1.062, 1.117, etc. By arranging the optical system to satisfy the above conditional expression, a ratio of half of the maximum effective aperture of the object side surface of the first lens to half of the image height corresponding to the maximum field of view angle of the optical system is reasonably configured, which is conducive to reasonably controlling the size of the object side surface of the first lens, thereby achieving the miniaturization of the optical system.

In some embodiments, the optical system may satisfy the following conditional expression: 5.2≤TTL/SDL1≤6.3. Wherein, SDL1 is the larger of half of the maximum effective aperture of the object side surface of the first lens and half of the maximum effective aperture of the imaging side surface of the first lens. For example, TTL/SDL1 may be 5.525, 5.872, 5.302, 5.289, 6.217, 5.210, 5.963, 6.286, etc. By arranging the optical system to satisfy the above conditional expression, a ratio of the total length of the optical system to the larger of half of the maximum effective aperture of the object side surface of the first lens and half of the maximum effective aperture of the imaging side surface of the first lens can be reasonably configured. When the total length of the optical system is constant, the size of the first lens can be reasonably restricted, which is conducive to limiting the head size of the optical system and achieving the miniaturization of the optical system.

In some embodiments, the optical system may satisfy the following conditional expression: 0.78≤SD9/SD1≤0.97. Wherein, SD9 is half of the maximum effective aperture of the object side surface of the fifth lens. For example, SD9/SD1 may be 0.963, 0.947, 0.783, 0.964, 0.906, 0.825, 0.791, 0.882, etc. By arranging the optical system to satisfy the above conditional expression, it is beneficial to reasonably configure a ratio of half of the maximum effective aperture of the object side surface of the first lens to half of the maximum effective aperture of the object side surface of the fifth lens, thereby controlling an outer diameter size of the lens group in the optical system to reduce the thickness of the optical system in the radial direction, so that the requirement of miniaturizing the optical system can be achieved.

In some embodiments, the optical system may satisfy the following conditional expression: 0.9≤F3/F≤1.2. Wherein, F3 is an effective focal length of the third lens, and F is the effective focal length of the optical system. For example, F3/F may be 0.945, 0.921, 0.977, 1.108, 1.032, 0.901, 1.189, 1.068, etc. By arranging the optical system to satisfy the above conditional expression, it is beneficial to properly coordinate the refractive power of the third lens in the optical system, allowing the surface shape design of the third lens to be simpler and more flexible, reducing aberrations, and simplifying the balance between the aberration correction and the imaging quality of the overall optical system.

In some embodiments, the optical system may satisfy the following conditional expression: 10≤F4/CT4≤−1.5. Wherein, F4 is an effective focal length of the fourth lens, and CT4 is the thickness of the fourth lens at the optical axis. For example, F4/CT4 may be −7.859, −9.547, −1.972, −2.784, −1.716, −4.275, −6.934, −9.935, etc. By arranging the optical system to satisfy the above conditional expression, it is beneficial to reasonably configure a ratio of the effective focal length of the fourth lens to the thickness of the fourth lens at the optical axis, which is conducive to simplifying the surface shape setting of the fourth lens.

In some embodiments, the optical system may satisfy the following conditional expression: −1.2≤F/F34≤−0.2. Wherein, F34 is a combined effective focal length of the third lens and the fourth lens. For example, F/F34 may be −0.342, −0.222, −0.273, −1.086, −0.293, −1.162, −0.873, −0.588, etc. By arranging the optical system to satisfy the above conditional expression, it is beneficial to reasonably configure a ratio of the effective focal length of the optical system to the effective focal length of the cemented lens composed of the third lens and the fourth lens, which is conducive to correcting chromatic aberration and balancing various aberrations, improving the resolution ability of the optical system, effectively reducing the tolerance sensitivity of the optical system, and thereby enhancing the imaging quality of the optical system.

In some embodiments, the optical system may satisfy the following conditional expression: −1.4 mm⁻¹≤(VD3−VD4)/F34≤−0.35 mm⁻¹. Wherein, VD3 is an Abbe number of the third lens, and VD4 is an Abbe number of the fourth lens. For example, (VD3−VD4)/F34 may be −0.664, −0.389, −0.512, −1.311, −0.596, −0.962, −1.173, −0.802, etc. By arranging the optical system to satisfy the above conditional expression, a ratio of a difference between the Abbe number of the third lens and the Abbe number of the four lens to the combined effective focal length of the third lens and the fourth lens is reasonably configured, which is conducive to effectively correcting chromatic aberration in the optical system, restoring the authenticity of the colors during imaging, thereby improving the imaging quality of the optical system.

In some embodiments, the optical system may satisfy the following conditional expression: 0.67≤CT1/ET1≤0.96. Wherein, CT1 is a thickness of the first lens at the optical axis, and ET1 is an edge thickness of the first lens, that is, a distance along the optical axis from the maximum effective aperture of the object side surface of the first lens to the maximum effective aperture of the imaging side surface of the first lens. For example, CT1/ET1 may be 0.907, 0.956, 0.698, 0.736, 0.940, 0.677, 0.869, 0.793, etc. By arranging the optical system to satisfy the above conditional expression, a ratio of the thickness of the first lens at the optical axis to the edge thickness of the first lens is reasonably configured, which is conducive to simplifying the production and manufacturing of the first lens.

In some embodiments, the optical system may satisfy the following conditional expression: 1.15≤CT2/ET2≤1.55. Wherein, CT2 is the thickness of the second lens at the optical axis, and ET2 is an edge thickness of the second lens, that is, a distance along the optical axis from the maximum effective aperture of the object side surface of the second lens to the maximum effective aperture of the imaging side surface of the second lens. For example, CT2/ET2 may be 1.335, 1.181, 1.328, 1.524, 1.386, 1.542, 1.274, 1.481, etc. By arranging the optical system to satisfy the above conditional expression, a ratio of the thickness of the second lens at the optical axis to the edge thickness of the second lens is reasonably configured, which is conducive to simplifying the production and manufacturing of the second lens.

In some embodiments, the optical system may satisfy the following conditional expression: −14≤(F1+F2)/F<−1.5. Wherein, F1 is an effective focal length of the first lens, and F2 is an effective focal length of the second lens. For example, (F1+F2)/F may be −1.886, −13.550, −1.886, −2.592, −4.374, −10.452, −8.831, −11.176, etc. By arranging the optical system to satisfy the above conditional expression, a ratio of the sum of the effective focal lengths of the first lens and the second lens to the effective focal length of the optical system is reasonably configured, which is conducive to mutual correction of the aberrations produced by the first lens and the second lens, and thereby improving the imaging quality of the optical system.

In some embodiments, the optical system may satisfy the following conditional expression: −2.5≤SAG11/CT6≤−1. Wherein, SAG11 is a vector height at the maximum effective aperture of the object side surface of the sixth lens, that is, a distance between an intersection point of the object side surface of the sixth lens and the optical axis to the maximum effective aperture of the object side surface of the sixth lens in the direction of the optical axis, and CT6 is a thickness of the sixth lens at the optical axis. For example, SAG11/CT6 may be −1.061, −1.080, −1.061, −1.050, −2.459, −1.526, −2.062, −2.396, etc. By arranging the optical system to satisfy the above conditional expression, it is beneficial to reasonably control the refractive power and thickness of the sixth lens at each point in the direction perpendicular to the optical axis, thereby avoiding the sixth lens being too thick or too thin, reducing the incident angle of light on the object side surface of the sixth lens, and reducing the tolerance sensitivity of the optical system.

In some embodiments, the optical system may satisfy the following conditional expression: 7≤|SAG11/SAG12|≤31. Wherein, SAG12 is a vector height at the maximum effective aperture of the imaging side surface of the sixth lens, that is, a distance between an intersection point of the imaging side surface of the sixth lens and the optical axis to the maximum effective aperture of the imaging side surface of the sixth lens in the direction of the optical axis. For example, |SAG11/SAG12| may be 11.460, 7.390, 23.296, 10.855, 30.204, 15.832, 19.583, 26.921, etc. By arranging the optical system to satisfy the above conditional expression, it is beneficial to reasonably control the shape of the sixth lens and correct the distortion and the field curvature produced by the object side surface of the sixth lens.

In some embodiments, the optical system may satisfy the following conditional expression: 0.25≤CT6/ET6≤0.55. Wherein, ET6 is an edge thickness of the sixth lens, that is, a distance along the optical axis from the maximum effective aperture of the object side surface of the sixth lens to the maximum effective aperture of the imaging side surface of the sixth lens. For example, CT6/ET6 may be 0.464, 0.449, 0.496, 0.512, 0.296, 0.253, 0.543, 0.338, etc. By arranging the optical system to satisfy the above conditional expression, a ratio of the thickness of the sixth lens at the optical axis to the edge thickness of the sixth lens can be reasonably configured, which is beneficial to simplify the production and manufacturing of the sixth lens.

In some embodiments, the optical system may satisfy the following conditional expression: 1.1≤|(R3−R4)/(R3+R4)|≤6.3. Wherein, R3 is a radius of curvature of the object side surface of the second lens at the optical axis, and R4 is a radius of curvature of the imaging side surface of the second lens at the optical axis. For example, |(R3−R4)/(R3+R4)| may be 1.160, 3.776, 3.884, 6.217, 5.756, 4.825, 2.982, 6.036, etc. By arranging the optical system to satisfy the above conditional expression, it is beneficial to control the shape of the second lens, comprehensively balance the spherical aberration, the chromatic aberration and the field curvature of the optical system, and reduce the risk of ghosting, thereby improving the resolution of the optical system.

In some embodiments, the optical system may satisfy the following conditional expression: 8≤|R12/R11|≤31. Wherein, R11 is a radius of curvature of the object side surface of the sixth lens at the optical axis, and R12 is a radius of curvature of the imaging side surface of the sixth lens at the optical axis. For example, |R12/R11| may be 12.762, 8.373, 24.726, 10.910, 30.802, 15.017, 22.982, 29.554, etc. By arranging the optical system to satisfy the above conditional expression, it is beneficial to reasonably configure a ratio of the radius of curvature of the object side surface of the sixth lens at the optical axis to the radius of curvature of the imaging side surface of the sixth lens at the optical axis, control the shape of the sixth lens, comprehensively balance the spherical aberration, the chromatic aberration and the field curvature of the optical system, reduce the risk of ghosting, improve the resolution of the optical system, and at the same time, it is also beneficial to reduce the processing difficulty of the sixth lens.

In some embodiments, the optical system may satisfy the following conditional expression: 4.5≤|R12/F|≤19. For example, |R12/F| may be 8.523, 4.784, 12.257, 5.915, 18.283, 10.462, 14.982, 17.554, etc. By arranging the optical system to satisfy the above conditional expression, it is beneficial to reasonably configure a ratio of the radius of curvature of the imaging side surface of the sixth lens to the effective focal length of the optical system, which can increase the image height of the optical system under the condition that the field of view angle remains unchanged, thereby allowing the optical system to receive light at a larger angle, reducing the distortion of the optical system, and at the same time, the turning angle of the light when reaching the sixth lens can be smaller, which is beneficial to reduce the tolerance sensitivity of the optical system.

In some embodiments, the optical system may satisfy the following conditional expression: 1.75≤TTL/F≤2.4. For example, TTL/F may be 2.060, 1.936, 1.797, 1.806, 2.376, 1.757, 2.282, 2.154, etc. By arranging the optical system to satisfy the above conditional expression, it is beneficial to rationally configure a ratio of the distance from the object side surface of the first lens to the image plane of the optical system along the optical axis to the effective focal length of the optical system, so that the optical system has a smaller total optical length and achieves the characteristic of miniaturization.

In some embodiments, the optical system may satisfy the following conditional expression: 2.45≤F/IMGH≤3.8. For example, F/IMGH may be 2.528, 2.768, 3.666, 3.740, 2.472, 3.062, 2.982, 3.554, etc. By arranging the optical system to satisfy the above conditional expression, the refractive power of the optical system is matched with the size of the image plane, thereby improving the imaging quality of the optical system.

In some embodiments, the optical system may satisfy the following conditional expression: 101≤FOV×F/IMGH≤113. For example, FOV×F/IMGH may be 101.122, 110.714, 109.978, 112.214, 111.247, 104.521, 106.622, 107.623, etc. By arranging the optical system to satisfy the above conditional expression, it is beneficial to achieve a large image height effect while having a large field of view angle, thereby facilitating matching with a larger-sized photosensitive chip and improving the imaging quality of the optical system.

In some embodiments, the optical system may satisfy the following conditional expression: −15≤F1/F<−2.5. For example, F1/F may be −2.896, −14.494, −2.806, −3.528, −5.327, −13.017, −8.982, −10.554, etc. By arranging the optical system to satisfy the above conditional expression, it is beneficial for the refractive power of the first lens to be properly matched in the optical system, allowing the surface shape design of the first lens to be simpler and more flexible, enabling the first lens to support a larger field of view angle and a large aperture; at the same time, it is also beneficial for converging the light incident from the first lens to the optical system, delaying the incident angle of the light, reducing aberration, and simplifying the balance between the aberration correction and the imaging quality of the overall optical system.

In some embodiments, the optical system may satisfy the following conditional expression: 0.9≤F2/F≤1.1. For example, F2/F may be 1.010, 0.944, 0.920, 0.936, 0.953, 1.087, 1.032, 1.054, etc. By arranging the optical system to satisfy the above conditional expression, it is beneficial for the refractive power of the second lens to be properly matched in the optical system, allowing the surface shape design of the second lens to be simpler and more flexible, reducing aberration, and simplifying the balance between the aberration correction and the imaging quality of the overall optical system.

In some embodiments, the optical system may satisfy the following conditional expression: −0.75≤F4/F<−0.45. For example, F4/F may be −0.675, −0.737, −0.625, −0.471, −0.719, −0.517, −0.582, −0.454, etc. By arranging the optical system to satisfy the above conditional expression, it is beneficial for the refractive power of the fourth lens to be properly matched in the optical system, allowing the surface shape design of the fourth lens to be simpler and more flexible, reducing aberration, and simplifying the balance between the aberration correction and the imaging quality of the overall optical system.

In some embodiments, the optical system may satisfy the following conditional expression: 0.6≤F5/F≤1.9. Wherein, F5 is an effective focal length of the fifth lens. For example, F5/F may be 1.069, 1.879, 1.208, 0.633, 1.604, 0.745, 0.976, 1.592, etc. By arranging the optical system to satisfy the above conditional expression, it is beneficial for the refractive power of the fifth lens to be properly matched in the optical system, allowing the surface shape design of the fifth lens to be simpler and more flexible, reducing aberration, and simplifying the balance between the aberration correction and the imaging quality of the overall optical system.

In some embodiments, the optical system may satisfy the following conditional expression:−1≤F6/F<−0.75. Wherein, F6 is an effective focal length of the sixth lens. For example, F6/F may be −0.989, −0.813, −0.789, −0.864, −0.984, −0.753, −0.852, −0.905, etc. By arranging the optical system to satisfy the above conditional expression, it is beneficial for the refractive power of the sixth lens to be properly matched in the optical system, allowing the surface shape design of the sixth lens to be simpler and more flexible, reducing aberration and simplifying the balance between the aberration correction and the imaging quality of the overall optical system.

In some embodiments, the optical system may satisfy the following conditional expression: 0.15≤R1/R2≤0.9. Wherein, R1 is a radius of curvature of the object side surface of the first lens at the optical axis, and R2 is a radius of curvature of the imaging side surface of the first lens at the optical axis. For example, R1/R2 may be 0.165, 0.883, 0.628, 0.708, 0.640, 0.256, 0.489, 0.794, etc. By arranging the optical system to satisfy the above conditional expression, it is beneficial to rationally configure a ratio of the radius of curvature of the object side surface of the first lens at the optical axis to the radius of curvature of the imaging side surface of the first lens at the optical axis, control the shape of the first lens, comprehensively balance the spherical aberration, the chromatic aberration and the field curvature of the optical system, reduce the risk of ghosting, and improve the resolution of the optical system; at the same time, it is also beneficial to reduce the processing difficulty of the first lens.

In some embodiments, the optical system may satisfy the following conditional expression: −2≤R3/R4≤0. Wherein, R3 is the radius of curvature of the object side surface of the second lens at the optical axis, and R4 is the radius of curvature of the imaging side surface of the second lens at the optical axis. For example, R3/R4 may be −0.074, −1.720, −0.591, −0.723, −1.421, −0.215, −1.052, −1.932, etc. By arranging the optical system to satisfy the above conditional expression, it is beneficial to rationally configure a ratio of the radius of curvature of the object side surface of the second lens at the optical axis to the radius of curvature of the imaging side surface of the second lens at the optical axis, control the shape of the second lens, comprehensively balance the spherical aberration, the chromatic aberration and the field curvature of the optical system, reduce the risk of ghosting, and improve the resolution of the optical system; at the same time, it is also beneficial to reduce the processing difficulty of the second lens.

In some embodiments, the optical system may satisfy the following conditional expression: −14≤R5/R6≤−0.9. Wherein, R5 is a radius of curvature of the object side surface of the third lens at the optical axis, and R6 is a radius of curvature of the imaging side surface of the third lens at the optical axis. For example, R5/R6 may be −6.828, −7.982, −0.991, −13.390, −10.852, −1.017, −3.982, −12.554, etc. By arranging the optical system to satisfy the above conditional expression, it is beneficial to rationally configure a ratio of the radius of curvature of the object side surface of the third lens at the optical axis to the radius of curvature of the imaging side surface of the third lens at the optical axis, control the shape of the third lens, comprehensively balance the spherical aberration, the chromatic aberration and the field curvature of the optical system, reduce the risk of ghosting, and improve the resolution of the optical system; at the same time, it is also beneficial to reduce the processing difficulty of the third lens.

In some embodiments, the optical system may satisfy the following conditional expression: −1.7<R7/R8≤−0.45. Wherein, R7 is a radius of curvature of the object side surface of the fourth lens at the optical axis, and R8 is a radius of curvature of the imaging side surface of the fourth lens at the optical axis. For example, R7/R8 may be −0.648, −0.467, −1.252, −1.678, −0.553, −1.017, −0.982, −1.554, etc. By arranging the optical system to satisfy the above conditional expression, it is beneficial to rationally configure a ratio of the curvature radius of the object side surface of the fourth lens at the optical axis to the curvature radius of the imaging side surface of the fourth lens at the optical axis, control the shape of the fourth lens, comprehensively balance the spherical aberration, the chromatic aberration and the field curvature of the optical system, reduce the risk of ghost, and improve the resolution of the optical system; at the same time, it is also beneficial to reduce the processing difficulty of the fourth lens.

In some embodiments, the optical system may satisfy the following conditional expression: −6≤R9/R10≤0. Wherein, R9 is a radius of curvature of the object side surface of the fifth lens at the optical axis, and R10 is a radius of curvature of the imaging side surface of the fifth lens at the optical axis. For example, R9/R10 may be −2.060, −1.000, −0.365, −0.045, −5.821, −4.017, −3.982, −2.554, etc. By arranging the optical system to satisfy the above conditional expression, it is beneficial to reasonably configure a ratio of the radius of curvature of the object side surface of the fifth lens at the optical axis to the radius of curvature of the imaging side surface of the fifth lens at the optical axis, control the shape of the fifth lens, comprehensively balance the spherical aberration, the chromatic aberration and the field curvature of the optical system, reduce the risk of ghosting, and improve the resolution of the optical system; at the same time, it is also beneficial to reduce the processing difficulty of the fifth lens.

In some embodiments, the optical system may also include a filter. The filter may be an infrared cut-off filter, an infrared bandpass filter, or a dual-pass filter. In this application, the filter is an infrared cut-off filter, which is used to filter out infrared light and only allow visible light to pass through, thereby allowing the imaging to be more in line with human visual experience. Of course, the filter may be an infrared bandpass filter, which is fixedly set relative to each lens in the optical system. The infrared bandpass filter is used to pass infrared light with a central wavelength, has the function of filtering out background stray light, and is used for infrared lenses. In addition, the filter may be a dual-pass filter, which can simultaneously highly transmit visible light and pass through part of the infrared light, thereby achieving different band selection. It can not only achieve visible light imaging but also achieve infrared imaging, thus achieving day and night universal use. The filter may be assembled together with each lens as part of the optical system. In some embodiments, the filter may be an independent component outside the optical system, and the filter may be installed between the optical system and the photosensitive chip when the optical system and the photosensitive chip are assembled. It can be understood that the filter may be made of optical glass with a coating, or colored glass, or other materials, the specific choice can be made according to actual needs, and no specific limitations are made in this embodiment. In some embodiments, the filtering effect can also be achieved by setting a filtering coating on at least one of the first to fifth lenses.

In some embodiments, at least one lens in the optical system may have a spherical surface shape. The design of the spherical surface shape may reduce the difficulty of lens preparation and lower the production cost. In some embodiments, at least one lens in the optical system may have an aspherical surface shape. When at least one side surface of the lens (object side surface or imaging side surface) is aspherical, it can be said that the lens has an aspherical surface shape. In some embodiments, both the object side surface and the imaging side surface of each lens may be designed as aspherical surfaces. The aspherical design can help the optical system more effectively eliminate aberrations and improve imaging quality. In some embodiments, in order to balance production cost, production difficulty, imaging quality, assembly difficulty, etc., the surface design of each lens in the optical system may be a combination of spherical and aspherical surface shapes. In some embodiments, the second lens may have an aspherical surface shape, and the first lens, the third lens, the fourth lens, the fifth lens, and the sixth lens have spherical surface shapes.

In some embodiments, a material of at least one lens in the optical system may glass (GL). For example, the first lens L1 closest to the object side is made of glass. By taking advantage of the temperature drift elimination effect of the glass material of the first lens, the impact of environmental temperature changes on the optical system can be effectively reduced, thereby maintaining better and more stable imaging quality. In some embodiments, at least one lens in the optical system may be made of plastic (PC), such as polycarbonate or cellulose acetate. Lenses made of plastic can reduce the production cost of the optical system, while lenses made of glass can withstand higher or lower temperatures and have excellent optical performance and better stability. In some embodiments, lenses of different materials can be arranged in the optical system, that is, a design combining glass lenses and plastic lenses can be adopted, but the specific configuration relationship can be determined according to actual needs and is not exhaustively listed here.

### FIRST EMBODIMENT

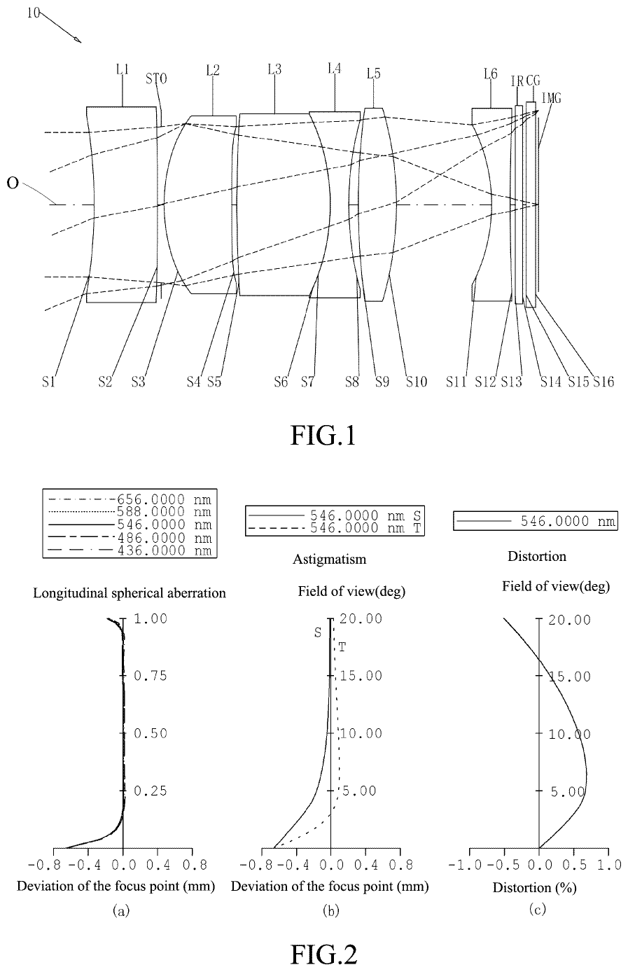

FIG. 1 is a schematic structural diagram of the optical system 10 of the first embodiment, the optical system 10 sequentially includes a first lens L1 having negative refractive power, a second lens L2 having positive refractive power, a third lens L3 having positive refractive power, a fourth lens L4 having negative refractive power, a fifth lens L5 having positive refractive power, and a sixth lens L6 having negative refractive power along an optical axis O from an object side to an imaging side. An object side surface S1 of the first lens L1 is concave near the optical axis O, an imaging side surface S2 of the first lens L1 is convex near the optical axis O, an object side surface S3 of the second lens L2 is convex near the optical axis O, an imaging side surface S4 of the second lens L2 is convex near the optical axis O, an object side surface S5 of the third lens L3 is convex near the optical axis O, an imaging side surface S6 of the third lens L3 is convex near the optical axis O, an object side surface S7 of the fourth lens L4 is concave near the optical axis O, an imaging side surface S8 of the fourth lens L4 is concave near the optical axis O, an object side surface S9 of the fifth lens L5 is convex near the optical axis O, an imaging side surface S10 of the fifth lens L5 is convex near the optical axis O, an object side surface S11 of the sixth lens L6 is concave near the optical axis O, and an imaging side surface S12 of the sixth lens L6 is concave near the optical axis O.

In addition, the optical system 10 further includes an aperture STO, a filter IR, a protective glass CG, and an image plane IMG. In this embodiment, the aperture STO is arranged between the imaging side surface of the first lens L1 and the object side surface of the second lens L2 and used to control the amount of light entering. The filter IR is arranged between the sixth lens L6 and the protective glass CG, which includes an object side surface S13 and the imaging side surface S14. The filter IR is an infrared cut-off filter, which is used to filter out infrared light, so that the light entering the image plane IMG is visible light with a wavelength of 380 nm to 780 nm. A material of the infrared cut-off filter may be glass or plastic, and a coating may be coated on the surface of the infrared cut-off filter. The protective glass CG is arranged between the filter IR and the image plane IMG, which includes an object side surface S15 and an imaging side surface S16. The material of the first lens L1 to the sixth lens L6 may be glass or plastic. An effective pixel area of a photosensitive chip is located on the image plane, and an infrared photosensitive chip is arranged on the image plane IMG. The photosensitive chip captures different waveband information of the object for subsequent processing.

Table 1a shows the parameters of the optical system 10 of this embodiment, wherein, the radius Y is the radius of curvature of the object side surface or the imaging side surface with the corresponding surface number at the optical axis. Surface number S1 and surface number S2 are respectively the object side surface S1 and the imaging side surface S2 of the first lens L1. That is, in the same lens, a surface with a smaller surface number is the object side surface, a surface with a larger surface number is the imaging side surface. The first value in the “Thickness” parameter column of the first lens L1 is the thickness of the lens at the optical axis O, and the second value is a distance from the imaging side surface of the lens to a rear surface in an imaging side direction on the optical axis O. The focal length, the material, the refractive index, and Abbe number are all obtained under visible light with a reference wavelength of 546 nm. The units of Y radius, the thickness, and the effective focal length are all millimeters (mm).

TABLE 1a
First embodiment
F = 11.49 mm, FNO = 1.79, FOV = 40 deg, TTL = 23.670 mm

| | Name | | Y radius | Thickness | | | | Focal |
|---|---|---|---|---|---|---|---|---|
| Surface | Object | Surface | (mm) | (mm) | | Refractive | Abbe | length |
| number | side | type | infinity | infinity | Material | index | number | (mm) |
| S1 | L1 | sphere | −23.003 | 3.383 | glass | 1.835 | 42.721 | −33.275 |
| S2 | | sphere | −139.082 | 0.186 | | | | |
| STO | Aperture | sphere | infinity | 0.159 | | | | |
| S3 | L2 | asphere | 7.646 | 3.599 | glass | 1.619 | 63.855 | 11.606 |
| S4 | | asphere | −103.246 | 0.275 | | | | |
| S5 | L3 | sphere | 62.543 | 4.989 | glass | 1.755 | 52.322 | 10.860 |
| S6 | | sphere | −9.159 | 0.000 | | | | |
| S7 | L4 | sphere | −9.159 | 0.986 | glass | 1.699 | 30.050 | −7.753 |
| S8 | | sphere | 14.131 | 0.504 | | | | |
| S9 | L5 | sphere | 30.906 | 2.030 | glass | 1.835 | 42.725 | 12.280 |
| S10 | | sphere | −15.004 | 5.068 | | | | |
| S11 | L6 | sphere | −7.673 | 0.985 | glass | 1.620 | 36.346 | −11.361 |
| S12 | | sphere | 97.928 | 0.269 | | | | |
| S13 | IR | sphere | infinity | 0.400 | glass | 1.620 | 36.346 | |
| S14 | | sphere | infinity | 0.189 | | | | |
| S15 | CG | sphere | infinity | 0.500 | glass | 1.620 | 36.346 | |
| S16 | | sphere | infinity | 0.150 | | | | |
| IMG | Image | sphere | infinity | 0.000 | | | | |
| | plane | | | | | | | |

Wherein, F is an effective focal length of the optical system 10, FNO is an aperture number of the optical system 10, FOV is the maximum field of view angle of the optical system 10, and TTL is a distance from the object side surface of the first lens to the image plane along the optical axis, that is, a total optical length.

In this embodiment, the object side surface and the imaging side surface of the second lens L2 are both aspheric surfaces. The surface shape x of the aspheric surface can be defined by, but not limited to, the following aspherical formula:

$$Z = \frac{{cr}^{2}}{1 + \sqrt{1 - ( k + 1 ) {c}^{2} {r}^{2}}} + \sum {Air}^{i}$$

Wherein, Z is a distance from the corresponding point on the aspheric surface to the plane tangent to the surface vertex, h is a distance from the corresponding point on the aspheric surface to the optical axis, c is a curvature of the vertex of the aspheric surface, k is the cone coefficient, Ai is the coefficient corresponding to the i-th higher-order term of the aspheric surface.

Table 1b shows the higher-order term coefficients A4, A6, A8, A10, A12, A14, and A16 that can be used for aspheric surfaces S3 and S4 in the first embodiment.

TABLE 1b

| Surface | | | | | | | | |
|---|---|---|---|---|---|---|---|---|
| number | K | A4 | A6 | A8 | A10 | A12 | A14 | A16 |
| S3 | 5.9963E−01 | −1.6015E−05 | −6.6125E−06 | 3.0836E−06 | −4.9079E−07 | 4.5382E−08 | −2.1414E−09 | 4.0566E−11 |
| S4 | −2.1851E+06 | 5.5932E−04 | 9.3612E−05 | −1.2351E−05 | 1.1476E−06 | −4.2718E−08 | −4.0603E−11 | 3.4720E−11 |

(a) of FIG. 2 shows a longitudinal spherical aberration diagram of the optical system 10 in the first embodiment at wavelengths of 656.0000 nm, 588.0000 nm, 546.0000 nm, 486.0000 nm, and 436.0000 nm. Wherein, the abscissa along the X-axis direction represents the deviation of the focus point, which is a distance from the image plane to an intersection point of the light and the optical axis (in mm), and the ordinate along the Y-axis direction represents the normalized field of view. The longitudinal spherical aberration curves indicate the deviation of the focal points of light of different wavelengths after passing through the lenses of the optical system 10. It can be seen from (a) of FIG. 2 that the degree of deviation of the focal points of light of various wavelengths in the first embodiment tends to be consistent, and the blurring spots or chromatic aberration in the imaging picture are effectively suppressed, indicating that the imaging quality of the optical system 10 in this embodiment is well.

(b) of FIG. 2 is an astigmatism curve diagram of the optical system 10 in the first embodiment at a wavelength of 546.0000 nm. Wherein, the abscissa along the X-axis direction represents the deviation of the focus point in mm, and ordinate along the Y-axis direction represents in deg. S curve represents the sagittal field curvature at 546.0000 nm, and the T curve represents the tangential field curvature at 546.0000 nm. It can be seen from (b) of FIG. 2 that the field curvature of the optical system 10 is small, and the field curvature and the astigmatism at various fields of view are well corrected, resulting in clear imaging at both the center and the edge of the field of view.

(c) of FIG. 2 is a distortion diagram of the optical system 10 in the first embodiment at a wavelength of 546.0000 nm. Wherein, the abscissa along the X-axis direction represents the distortion in %, and the ordinate along the Y-axis direction represents the field of view in deg. The distortion curve indicates the distortion values corresponding to different field of view angles. It can be seen from (c) of FIG. 2 that the image distortion caused by the main beam is small at a wavelength of 546.0000 nm, and the imaging quality of the system is excellent.

It can be seen from (a) of FIG. 2, (b) of FIG. 2, and (c) of FIG. 2 that the optical system 10 in this embodiment has small aberration and good imaging quality, with excellent imaging performance.

### SECOND EMBODIMENT

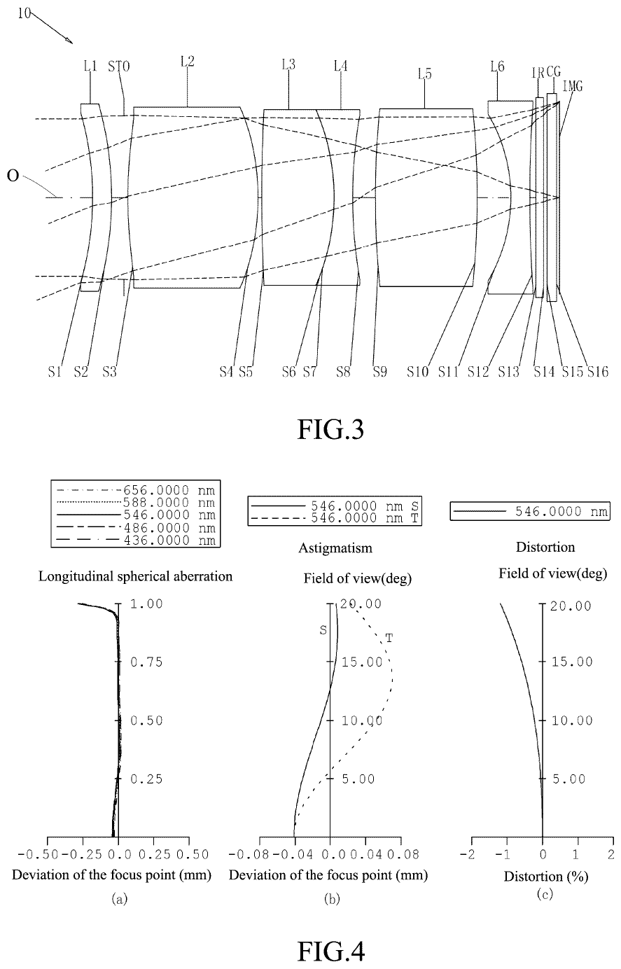

FIG. 3 is a schematic structural diagram of the optical system 10 of the second embodiment, the optical system 10 sequentially includes a first lens L1 having negative refractive power, a second lens L2 having positive refractive power, a third lens L3 having positive refractive power, a fourth lens L4 having negative refractive power, a fifth lens L5 having positive refractive power, and a sixth lens L6 having negative refractive power along an optical axis O from an object side to an imaging side. An object side surface S1 of the first lens L1 is concave near the optical axis O, an imaging side surface S2 of the first lens L1 is convex near the optical axis O, an object side surface S3 of the second lens L2 is convex near the optical axis O, an imaging side surface S4 of the second lens L2 is convex near the optical axis O, an object side surface S5 of the third lens L3 is convex near the optical axis O, an imaging side surface S6 of the third lens L3 is convex near the optical axis O, an object side surface S7 of the fourth lens L4 is concave near the optical axis O, an imaging side surface S8 of the fourth lens L4 is concave near the optical axis O, an object side surface S9 of the fifth lens L5 is convex near the optical axis O, an imaging side surface S10 of the fifth lens L5 is convex near the optical axis O, an object side surface S11 of the sixth lens L6 is concave near the optical axis O, and an imaging side surface S12 of the sixth lens L6 is concave near the optical axis O.

The other structures of the second embodiment are the same as those of the first embodiment, and can be referred to accordingly.

Table 2a shows the parameters of the optical system 10 of this embodiment, wherein, the focal length, the material, the refractive index, and Abbe number are all obtained under visible light with a reference wavelength of 546 nm. The units of Y radius, the thickness, and the effective focal length are all millimeters (mm), and the meanings of other parameters are the same as those in the first embodiment.

TABLE 2a
Second embodiment
F = 12.71 mm, FNO = 1.69, FOV = 40 deg, TTL = 24.609 mm

| | Name | | Y radius | Thickness | | | | Focal |
|---|---|---|---|---|---|---|---|---|
| Surface | Object | Surface | (mm) | (mm) | | Refractive | Abbe | length |
| number | side | type | infinity | infinity | Material | index | number | (mm) |
| S1 | L1 | sphere | −13.471 | 0.996 | glass | 1.835 | 42.721 | −184.220 |
| S2 | | sphere | −15.255 | 0.661 | | | | |
| STO | Aperture | sphere | infinity | 0.195 | | | | |
| S3 | L2 | asphere | 18.446 | 6.865 | glass | 1.619 | 63.855 | 11.999 |
| S4 | | asphere | −10.722 | 0.196 | | | | |
| S5 | L3 | sphere | 78.290 | 3.827 | glass | 1.755 | 52.322 | 11.712 |
| S6 | | sphere | −9.808 | 0.000 | | | | |
| S7 | L4 | sphere | −9.808 | 0.981 | glass | 1.699 | 30.050 | −9.369 |
| S8 | | sphere | 21.014 | 1.197 | | | | |
| S9 | L5 | sphere | 38.828 | 5.360 | glass | 1.835 | 42.725 | 23.879 |
| S10 | | sphere | −38.828 | 1.771 | | | | |
| S11 | L6 | sphere | −7.263 | 1.001 | glass | 1.620 | 36.346 | −10.337 |
| S12 | | sphere | 60.808 | 0.320 | | | | |
| S13 | IR | sphere | infinity | 0.400 | glass | 1.620 | 36.346 | |
| S14 | | sphere | infinity | 0.188 | | | | |
| S15 | CG | sphere | infinity | 0.500 | glass | 1.620 | 36.346 | |
| S16 | | sphere | infinity | 0.150 | | | | |
| IMG | Image | sphere | infinity | 0.000 | | | | |
| | plane | | | | | | | |

Table 2b gives the high-order term coefficients that can be used for each aspheric surface in the second embodiment, wherein the aspheric surface shapes can be defined by the formula given in the first embodiment.

TABLE 2b

| Surface | | | | | | | | |
|---|---|---|---|---|---|---|---|---|
| number | K | A4 | A6 | A8 | A10 | A12 | A14 | A16 |
| S3 | −1.1443E+00 | −2.5244E−04 | −1.7568E−05 | 1.0331E−06 | 2.7549E−08 | −1.1743E−08 | 7.3282E−10 | −1.5002E−11 |
| S4 | 4.9291E−01 | 2.6874E−04 | −7.9434E−05 | 1.1059E−05 | −7.7653E−07 | 1.8507E−08 | 5.0973E−10 | −2.4633E−11 |

(a) of FIG. 4, (b) of FIG. 4, and (c) of FIG. 4 respectively show the longitudinal spherical aberration diagram, astigmatism curve diagram, and distortion diagram of the optical system 10 of the second embodiment. The longitudinal spherical aberration curves represent the deviation of the focal points of light of different wavelengths after passing through the lenses of the optical system 10. The astigmatism curves represent the sagittal field curvature and the tangential field curvature. The distortion curves represent the distortion values corresponding to different field of view angles. It can be seen from FIG. 4 that the longitudinal spherical aberration, the field curvature and the distortion of optical system 10 are all well controlled, thus the optical system 10 of this embodiment has good imaging quality.

### THIRD EMBODIMENT

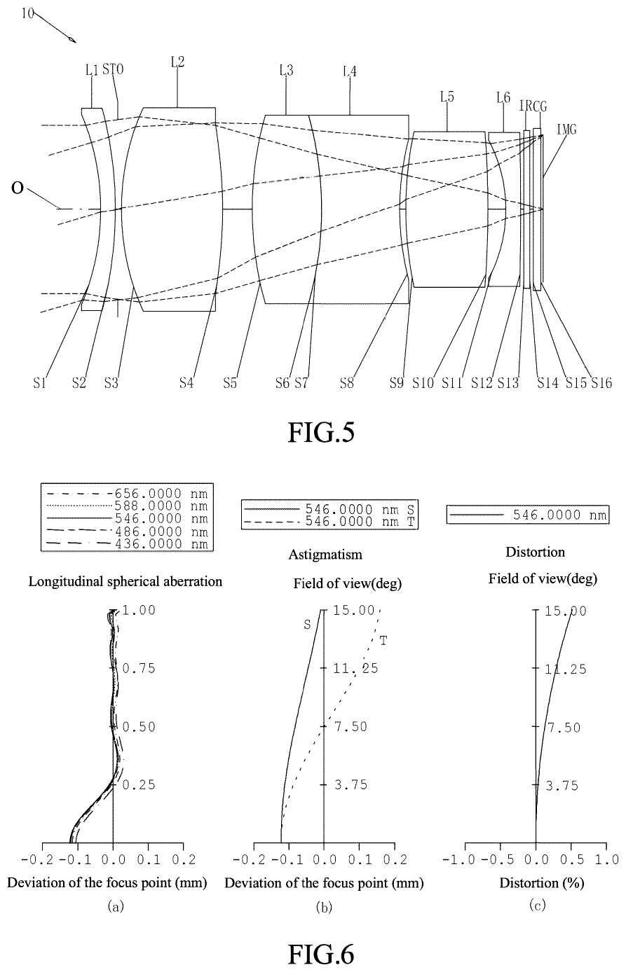

FIG. 5 is a schematic structural diagram of the optical system 10 of the third embodiment, the optical system 10 sequentially includes a first lens L1 having negative refractive power, a second lens L2 having positive refractive power, a third lens L3 having positive refractive power, a fourth lens L4 having negative refractive power, a fifth lens L5 having positive refractive power, and a sixth lens L6 having negative refractive power along an optical axis O from an object side to an imaging side. An object side surface S1 of the first lens L1 is concave near the optical axis O, an imaging side surface S2 of the first lens L1 is convex near the optical axis O, an object side surface S3 of the second lens L2 is convex near the optical axis O, an imaging side surface S4 of the second lens L2 is convex near the optical axis O, an object side surface S5 of the third lens L3 is convex near the optical axis O, an imaging side surface S6 of the third lens L3 is convex near the optical axis O, an object side surface S7 of the fourth lens L4 is concave near the optical axis O, an imaging side surface S8 of the fourth lens L4 is concave near the optical axis O, an object side surface S9 of the fifth lens L5 is convex near the optical axis O, an imaging side surface S10 of the fifth lens L5 is convex near the optical axis O, an object side surface S11 of the sixth lens L6 is concave near the optical axis O, and an imaging side surface S12 of the sixth lens L6 is convex near the optical axis O.

The other structures of the third embodiment are the same as those of the first embodiment, and can be referred to accordingly.

Table 3a shows the parameters of the optical system 10 of this embodiment, wherein, the focal length, the material, the refractive index, and Abbe number are all obtained under visible light with a reference wavelength of 546 nm. The units of Y radius, the thickness, and the effective focal length are all millimeters (mm), and the meanings of other parameters are the same as those in the first embodiment.

TABLE 3a
Third embodiment
F = 16.317 mm, FNO = 1.64, FOV = 30 deg, TTL = 29.314 mm

| | Name | | Y radius | Thickness | | | | Focal |
|---|---|---|---|---|---|---|---|---|
| Surface | Object | Surface | (mm) | (mm) | | Refractive | Abbe | length |
| number | side | type | infinity | infinity | Material | index | number | (mm) |
| S1 | L1 | sphere | −13.514 | 0.973 | glass | 1.835 | 42.721 | −45.786 |
| S2 | | sphere | −21.526 | 0.166 | | | | |
| STO | Aperture | sphere | infinity | 0.243 | | | | |
| S3 | L2 | asphere | 13.839 | 6.698 | glass | 1.620 | 63.764 | 15.016 |
| S4 | | asphere | −23.434 | 1.960 | | | | |
| S5 | L3 | sphere | 18.845 | 4.608 | glass | 1.620 | 60.339 | 15.944 |
| S6 | | sphere | −19.024 | 0.000 | | | | |
| S7 | L4 | sphere | −19.024 | 5.175 | glass | 1.771 | 29.736 | −10.204 |
| S8 | | sphere | 15.198 | 0.408 | | | | |
| S9 | L5 | sphere | 20.243 | 5.429 | glass | 1.773 | 49.519 | 19.709 |
| S10 | | sphere | −55.406 | 1.188 | | | | |
| S11 | L6 | sphere | −8.089 | 0.976 | glass | 1.653 | 39.480 | −12.867 |
| S12 | | sphere | −200.003 | 0.208 | | | | |
| S13 | IR | sphere | infinity | 0.400 | glass | 1.620 | 36.346 | |
| S14 | | sphere | infinity | 0.231 | | | | |
| S15 | CG | sphere | infinity | 0.500 | glass | 1.620 | 36.346 | |
| S16 | | sphere | infinity | 0.150 | | | | |
| IMG | Image | sphere | infinity | 0.000 | | | | |
| | plane | | | | | | | |

Table 3b gives the high-order term coefficients that can be used for each aspheric surface in the third embodiment, wherein the aspheric surface shapes can be defined by the formula given in the first embodiment.

TABLE 3b

| Surface | | | | | | | | |
|---|---|---|---|---|---|---|---|---|
| number | K | A4 | A6 | A8 | A10 | A12 | A14 | A16 |
| S3 | 1.2746E+00 | −3.2737E−05 | −4.1026E−06 | 1.9057E−07 | −1.7235E−10 | −3.2594E−10 | 1.1214E−11 | −1.1917E−13 |
| S4 | 1.4651E+01 | 5.2167E−04 | −5.8348E−05 | 7.3726E−06 | −5.0321E−07 | 1.9961E−08 | −4.2309E−10 | 3.7747E−12 |

(a) of FIG. 6, (b) of FIG. 6, and (c) of FIG. 6 respectively show the longitudinal spherical aberration diagram, astigmatism curve diagram, and distortion diagram of the optical system 10 of the third embodiment. The longitudinal spherical aberration curves represent the deviation of the focal points of light of different wavelengths after passing through the lenses of the optical system 10. The astigmatism curves represent the sagittal field curvature and the tangential field curvature. The distortion curves represent the distortion values corresponding to different field of view angles. It can be seen from FIG. 6 that the longitudinal spherical aberration, the field curvature and the distortion of optical system 10 are all well controlled, thus the optical system 10 of this embodiment has good imaging quality.

### FOURTH EMBODIMENT

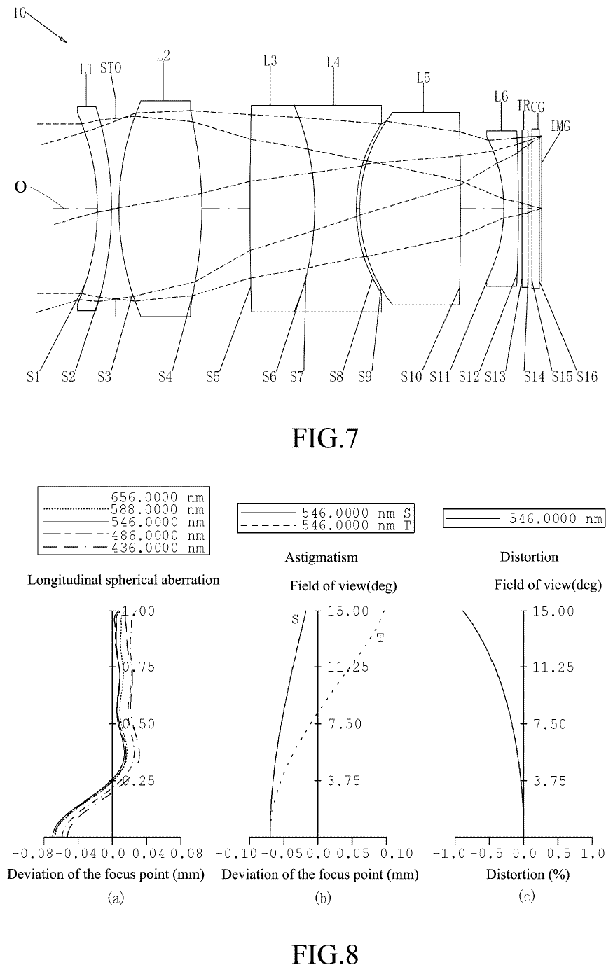

FIG. 7 is a schematic structural diagram of the optical system 10 of the fourth embodiment, the optical system 10 sequentially includes a first lens L1 having negative refractive power, a second lens L2 having positive refractive power, a third lens L3 having positive refractive power, a fourth lens L4 having negative refractive power, a fifth lens L5 having positive refractive power, and a sixth lens L6 having negative refractive power along an optical axis O from an object side to an imaging side. An object side surface S1 of the first lens L1 is concave near the optical axis O, an imaging side surface S2 of the first lens L1 is convex near the optical axis O, an object side surface S3 of the second lens L2 is convex near the optical axis O, an imaging side surface S4 of the second lens L2 is convex near the optical axis O, an object side surface S5 of the third lens L3 is convex near the optical axis O, an imaging side surface S6 of the third lens L3 is convex near the optical axis O, an object side surface S7 of the fourth lens L4 is concave near the optical axis O, an imaging side surface S8 of the fourth lens L4 is concave near the optical axis O, an object side surface S9 of the fifth lens L5 is convex near the optical axis O, an imaging side surface S10 of the fifth lens L5 is convex near the optical axis O, an object side surface S11 of the sixth lens L6 is concave near the optical axis O, and an imaging side surface S12 of the sixth lens L6 is convex near the optical axis O.

The other structures of the fourth embodiment are the same as those of the first embodiment, and can be referred to accordingly.

Table 4a shows the parameters of the optical system 10 of this embodiment, wherein, the focal length, the material, the refractive index, and Abbe number are all obtained under visible light with a reference wavelength of 546 nm. The units of Y radius, the thickness, and the effective focal length are all millimeters (mm), and the meanings of other parameters are the same as those in the first embodiment.

TABLE 4a
Fourth embodiment
F = 16.69 mm, FNO = 1.61, FOV = 30 deg, TTL = 30.135 mm

| | Name | | Y radius | Thickness | | | | Focal |
|---|---|---|---|---|---|---|---|---|
| Surface | Object | Surface | (mm) | (mm) | | Refractive | Abbe | length |
| number | side | type | infinity | infinity | Material | index | number | (mm) |
| S1 | L1 | sphere | −13.487 | 0.963 | glass | 1.846 | 40.094 | −58.887 |
| S2 | | sphere | −19.063 | 0.286 | | | | |
| STO | Aperture | sphere | infinity | 0.216 | | | | |
| S3 | L2 | asphere | 15.098 | 5.619 | glass | 1.594 | 67.002 | 15.624 |
| S4 | | asphere | −20.887 | 3.263 | | | | |
| S5 | L3 | sphere | 200.006 | 4.418 | glass | 1.755 | 52.323 | 18.490 |
| S6 | | sphere | −14.937 | 0.000 | | | | |
| S7 | L4 | sphere | −14.937 | 2.821 | glass | 1.673 | 32.181 | −7.855 |
| S8 | | sphere | 8.901 | 0.232 | | | | |
| S9 | L5 | sphere | 9.002 | 6.820 | glass | 1.822 | 42.715 | 10.572 |
| S10 | | sphere | −200.002 | 2.932 | | | | |
| S11 | L6 | sphere | −9.049 | 0.997 | glass | 1.689 | 31.161 | −14.417 |
| S12 | | sphere | −98.724 | 0.244 | | | | |
| S13 | IR | sphere | infinity | 0.400 | glass | 1.620 | 36.346 | |
| S14 | | sphere | infinity | 0.272 | | | | |
| S15 | CG | sphere | infinity | 0.500 | glass | 1.620 | 36.346 | |
| S16 | | sphere | infinity | 0.150 | | | | |
| IMG | Image | sphere | infinity | 0.000 | | | | |
| | plane | | | | | | | |

Table 4b gives the high-order term coefficients that can be used for each aspheric surface in the fourth embodiment, wherein the aspheric surface shapes can be defined by the formula given in the first embodiment.

TABLE 4b

| Surface | | | | | | | | |
|---|---|---|---|---|---|---|---|---|
| number | K | A4 | A6 | A8 | A10 | A12 | A14 | A16 |
| S3 | 3.4556E−01 | −1.7156E−05 | −2.0624E−06 | 7.7504E−09 | 7.9094E−09 | −4.5716E−10 | 1.0629E−11 | −9.1376E−14 |
| S4 | −5.9917E+01 | −5.8151E−04 | 2.1414E−05 | −2.2573E−07 | −1.9862E−08 | 1.0395E−09 | −2.0362E−11 | 1.4797E−13 |

(a) of FIG. 8, (b) of FIG. 8, and (c) of FIG. 8 respectively show the longitudinal spherical aberration diagram, astigmatism curve diagram, and distortion diagram of the optical system 10 of the fourth embodiment. The longitudinal spherical aberration curves represent the deviation of the focal points of light of different wavelengths after passing through the lenses of the optical system 10. The astigmatism curves represent the sagittal field curvature and the tangential field curvature. The distortion curves represent the distortion values corresponding to different field of view angles. It can be seen from FIG. 8 that the longitudinal spherical aberration, the field curvature and the distortion of optical system 10 are all well controlled, thus the optical system 10 of this embodiment has good imaging quality.

### FIFTH EMBODIMENT

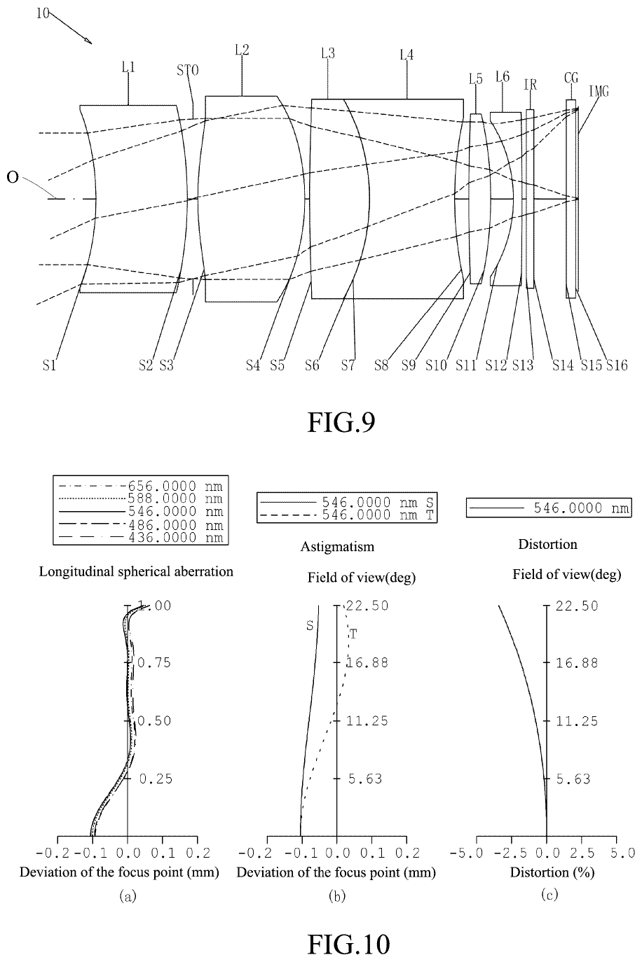

FIG. 9 is a schematic structural diagram of the optical system 10 of the fifth embodiment, the optical system 10 sequentially includes a first lens L1 having negative refractive power, a second lens L2 having positive refractive power, a third lens L3 having positive refractive power, a fourth lens L4 having negative refractive power, a fifth lens L5 having positive refractive power, and a sixth lens L6 having negative refractive power along an optical axis O from an object side to an imaging side. An object side surface S1 of the first lens L1 is concave near the optical axis O, an imaging side surface S2 of the first lens L1 is convex near the optical axis O, an object side surface S3 of the second lens L2 is convex near the optical axis O, an imaging side surface S4 of the second lens L2 is convex near the optical axis O, an object side surface S5 of the third lens L3 is convex near the optical axis O, an imaging side surface S6 of the third lens L3 is convex near the optical axis O, an object side surface S7 of the fourth lens L4 is concave near the optical axis O, an imaging side surface S8 of the fourth lens L4 is concave near the optical axis O, an object side surface S9 of the fifth lens L5 is convex near the optical axis O, an imaging side surface S10 of the fifth lens L5 is convex near the optical axis O, an object side surface S11 of the sixth lens L6 is concave near the optical axis O, and an imaging side surface S12 of the sixth lens L6 is convex near the optical axis O.

The other structures of the fifth embodiment are the same as those of the first embodiment, and can be referred to accordingly.

Table 5a shows the parameters of the optical system 10 of this embodiment, wherein, the focal length, the material, the refractive index, and Abbe number are all obtained under visible light with a reference wavelength of 546 nm. The units of Y radius, the thickness, and the effective focal length are all millimeters (mm), and the meanings of other parameters are the same as those in the first embodiment.

TABLE 5a
Fifth embodiment
F = 10.94 mm, FNO = 1.73, FOV = 45 deg, TTL = 25.989 mm

| | Name | | Y radius | Thickness | | | | Focal |
|---|---|---|---|---|---|---|---|---|
| Surface | Object | Surface | (mm) | (mm) | | Refractive | Abbe | length |
| number | side | type | infinity | infinity | Material | index | number | (mm) |
| S1 | L1 | sphere | −11.529 | 4.921 | glass | 1.835 | 42.721 | −58.281 |
| S2 | | sphere | −18.021 | 0.299 | | | | |
| STO | Aperture | sphere | infinity | 0.264 | | | | |
| S3 | L2 | asphere | 14.248 | 5.758 | glass | 1.619 | 63.855 | 10.424 |
| S4 | | asphere | −10.030 | 0.266 | | | | |
| S5 | L3 | sphere | 100.172 | 3.239 | glass | 1.755 | 52.322 | 11.288 |
| S6 | | sphere | −9.231 | 0.000 | | | | |
| S7 | L4 | sphere | −9.231 | 4.584 | glass | 1.699 | 30.050 | −7.864 |
| S8 | | sphere | 16.698 | 0.764 | | | | |
| S9 | L5 | sphere | 100.012 | 1.176 | glass | 1.835 | 42.725 | 17.546 |
| S10 | | sphere | −17.180 | 1.220 | | | | |
| S11 | L6 | sphere | −6.493 | 0.462 | glass | 1.620 | 36.346 | −10.764 |
| S12 | | sphere | −200.015 | 0.239 | | | | |
| S13 | IR | sphere | infinity | 0.400 | glass | 1.620 | 36.346 | |
| S14 | | sphere | infinity | 1.746 | | | | |
| S15 | CG | sphere | infinity | 0.500 | glass | 1.620 | 36.346 | |
| S16 | | sphere | infinity | 0.150 | | | | |
| IMG | Image | sphere | infinity | 0.000 | | | | |
| | plane | | | | | | | |

Table 5b gives the high-order term coefficients that can be used for each aspheric surface in the fifth embodiment, wherein the aspheric surface shapes can be defined by the formula given in the first embodiment.

TABLE 5b

| Surface | | | | | | | | |
|---|---|---|---|---|---|---|---|---|
| number | K | A4 | A6 | A8 | A10 | A12 | A14 | A16 |
| S3 | 3.8653E+00 | −7.1582E−04 | 3.8314E−05 | −1.0294E−05 | 1.2010E−06 | −8.4394E−08 | 3.2133E−09 | −5.1897E−11 |
| S4 | −1.7213E+00 | 2.3296E−05 | −8.7893E−05 | 1.3065E−05 | −1.2280E−06 | 6.6055E−08 | −1.8925E−09 | 2.2259E−11 |

(a) of FIG. 10, (b) of FIG. 10, and (c) of FIG. 10 respectively show the longitudinal spherical aberration diagram, astigmatism curve diagram, and distortion diagram of the optical system 10 of the fourth embodiment. The longitudinal spherical aberration curves represent the deviation of the focal points of light of different wavelengths after passing through the lenses of the optical system 10. The astigmatism curves represent the sagittal field curvature and the tangential field curvature. The distortion curves represent the distortion values corresponding to different field of view angles. It can be seen from FIG. 10 that the longitudinal spherical aberration, the field curvature and the distortion of optical system 10 are all well controlled, thus the optical system 10 of this embodiment has good imaging quality.

Table 6 shows the values of FOV, TTL/IMGH, FOV/FNO, FNO, TTL*IMGH/F, (CT3+CT4)/TTL, (CT2+CT3)/CT23, CT3/CT4, SD1/IMGH, TTL/SDL1, SD9/SD1, F3/F, F4/CT4, F/F34, (VD3−VD4)/F34, CT1/ET1, CT2/ET2, (F1+F2)/F, SAG11/CT6, |SAG11/SAG12|, CT6/ET6, | (R3-R4)/(R3+R4)|, |R12/R11|,|R12/F|, TTL/F, F/IMGH, FOV*F/IMGH, F1/F, F2/F, F4/F, F5/F, F6/F, R1/R2, R3/R4, R5/R6, R7/R8, and R9/R10 in the optical system 10 of the first to fifth embodiments.

TABLE 6

| | First | Second | Third | Fourth | Fifth |
|---|---|---|---|---|---|
| | embodiment | embodiment | embodiment | embodiment | embodiment |
| FOV (deg) | 40 | 40 | 30 | 30 | 45 |
| TTL/IMGH | 5.208 | 5.359 | 6.586 | 6.754 | 5.873 |
| FOV/FNO (deg) | 22.346 | 23.669 | 18.293 | 18.634 | 26.012 |
| FNO | 1.790 | 1.690 | 1.640 | 1.610 | 1.730 |
| TTL * IMGH/F (mm) | 9.363 | 8.891 | 7.996 | 8.056 | 10.513 |
| (CT3 + CT4)/TTL | 0.252 | 0.195 | 0.334 | 0.240 | 0.301 |
| (CT2 + CT3)/CT23 | 31.268 | 54.449 | 5.769 | 3.076 | 33.850 |
| CT3/CT4 | 5.058 | 3.900 | 0.890 | 1.566 | 0.707 |
| SD1/IMGH | 0.943 | 0.889 | 1.222 | 1.255 | 0.945 |
| TTL/SDL1 | 5.525 | 5.872 | 5.302 | 5.289 | 6.217 |
| SD9/SD1 | 0.963 | 0.947 | 0.783 | 0.964 | 0.906 |
| F3/F | 0.945 | 0.921 | 0.977 | 1.108 | 1.032 |
| F4/CT4 | -7.859 | -9.547 | -1.972 | -2.784 | -1.716 |
| F/F34 | -0.342 | -0.222 | -0.273 | -1.086 | -0.293 |
| (VD3 - VD4)/ | -0.664 | -0.389 | -0.512 | -1.311 | -0.596 |
| F34 (mm-1) | | | | | |
| CT1/ET1 | 0.907 | 0.956 | 0.698 | 0.736 | 0.940 |
| CT2/ET2 | 1.335 | 1.181 | 1.328 | 1.524 | 1.386 |
| (F1 + F2)/F | -1.886 | -13.550 | -1.886 | -2.592 | -4.374 |
| SAG11/CT6 | -1.061 | -1.080 | -1.061 | -1.050 | -2.459 |
| \|SAG11/SAG12\| | 11.460 | 7.390 | 23.296 | 10.855 | 30.204 |
| CT6/ET6 | 0.464 | 0.449 | 0.496 | 0.512 | 0.296 |
| (R3 - R4)/(R3 + R4)\| | 1.160 | 3.776 | 3.884 | 6.217 | 5.756 |
| \|R12/R11\| | 12.762 | 8.373 | 24.726 | 10.910 | 30.802 |
| R12/F | 8.523 | 4.784 | 12.257 | 5.915 | 18.283 |
| TTL/F | 2.060 | 1.936 | 1.797 | 1.806 | 2.376 |
| F/IMGH | 2.528 | 2.768 | 3.666 | 3.740 | 2.472 |
| FOV * F/IMGH | 101.122 | 110.714 | 109.978 | 112.214 | 111.247 |
| F1/F | -2.896 | -14.494 | -2.806 | -3.528 | -5.327 |
| F2/F | 1.010 | 0.944 | 0.920 | 0.936 | 0.953 |
| F4/F | -0.675 | -0.737 | -0.625 | -0.471 | -0.719 |
| F5/F | 1.069 | 1.879 | 1.208 | 0.633 | 1.604 |
| F6/F | -0.989 | -0.813 | -0.789 | -0.864 | -0.984 |
| R1/R2 | 0.165 | 0.883 | 0.628 | 0.708 | 0.640 |
| R3/R4 | -0.074 | -1.720 | -0.591 | -0.723 | -1.421 |
| R5/R6 | -6.828 | -7.982 | -0.991 | -13.390 | -10.852 |
| R7/R8 | -0.648 | -0.467 | -1.252 | -1.678 | -0.553 |
| R9/R10 | -2.060 | -1.000 | -0.365 | -0.045 | -5.821 |

As can be seen from Table 6, the optical systems of the first to fifth embodiments all satisfy the following conditional expressions: 30deg≤FOV≤45deg, 5.2≤TTL/IMGH≤6.8, 18deg≤FOV/FNO≤27deg, 1.6≤FNO≤1.8, 7.9 mm≤TTL*IMGH/F≤11 mm, 0.19≤(CT3+CT4)/TTL≤0.35, 3≤(CT2+CT3)/CT23≤55, 0.7≤CT3/CT4≤5.1, 0.85≤SD1/IMGH≤1.3, 5.2≤TTL/SDL1≤6.3, 0.78≤SD9/SD1≤0.97, 0.9≤F3/F≤1.2,−10≤F4/CT4≤−1.5, −1.2≤F/F34≤−0.2, −1.4 mm−1< (VD3−VD4)/F34≤−0.35 mm−1, 0.67≤CT1/ET1≤0.96, 1.15≤CT2/ET2≤1.55, −14≤(F1+F2)/F<−1.5, −2.5≤SAG11/CT6≤−1,7|SAG11/SAG12|<31, 0.25≤CT6/ET6≤0.55, 1.1<| (R3-R4)/(R3+R4)|≤6.3, 8≤|R12/R11|<31, 4.5≤|R12/F|≤19, 1.75≤TTL/F≤2.4, 2.45≤F/IMGH≤3.8, 101≤FOV*F/IMGH≤113, −15≤F1/F<−2.5, 0.9≤F2/F≤1.1, −0.75≤F4/F<−0.45, 0.6≤F5/F<1.9, −1≤F6/F≤−0.75, 0.15≤R1/R2≤0.9, −2≤R3/R4≤0, −14≤R5/R6≤−0.9, −1.7≤R7/R8≤−0.45 and −6≤R9/R10≤0.

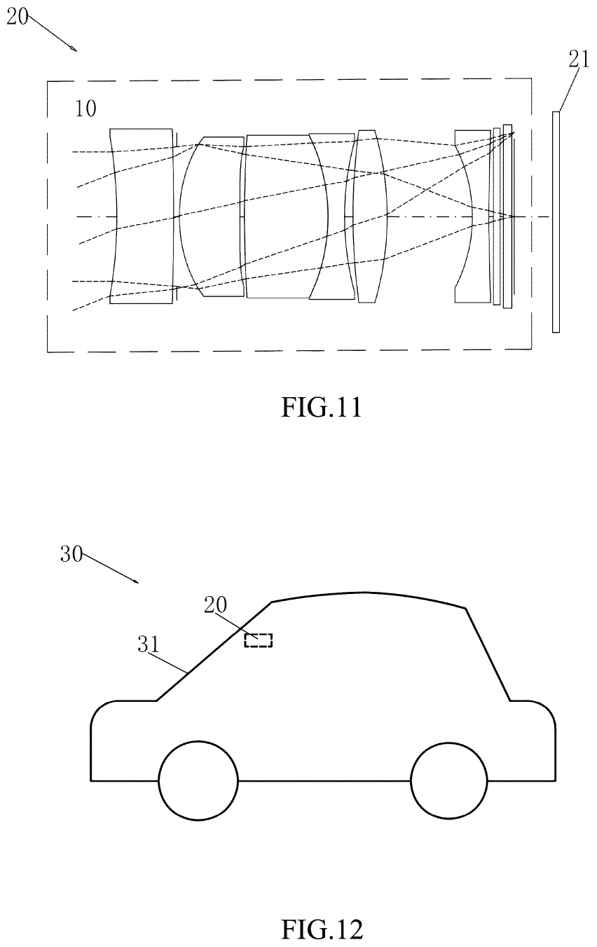

Referring to FIG. 11, the present disclosure also discloses an image module 20. The image module 20 includes a photosensitive chip 21 and the optical system 10 as described in any of the above embodiments. The photosensitive chip 21 is arranged on the imaging side of the optical system 10. A photosensitive surface of the photosensitive chip 21 is located on the image plane of the optical system 10, and the light from the object passing through the lenses and transmitted to the photosensitive surface can be converted into an electrical signal of the image. The photosensitive chip 21 may be a complementary metal oxide semiconductor (CMOS) or a charge-coupled device (CCD). The image module 20 may be an imaging module integrated in an electronic device 30 or an independent lens. By incorporating the optical system 10 provided by the present disclosure into the image module 20, the image module 20 can have the characteristics of miniaturization, high imaging clarity and large field of view angle through reasonable design of the surface shape and refractive power of each lens in the optical system 10.

Referring to FIG. 12, the present disclosure also discloses an electronic device 30. The electronic device 30 includes a housing 31 and the above-mentioned image module 20. The image module 20 is arranged in the housing 31. The electronic device 30 may be, but is not limited to, an automobile, a monitoring device, a smart phone, a computer and a smart watch, etc. By incorporating the image module 20 provided by the present disclosure into the electronic device 30, the electronic device 30 can have the characteristics of miniaturization, high imaging clarity and large field of view angle.

The above-disclosed are merely some of the preferred embodiments of the present application. Of course, it cannot be used to limit the scope of the rights of the present application. Ordinary technicians in this field can understand and implement all or part of the processes of the above embodiments, and equivalent changes made in accordance with the claims of the present application still fall within the scope covered by the present application.

What is claimed is:

1. An optical system, from an object side to an imaging side along an optical axis, sequentially comprising:
a first lens having negative refractive power, an object side surface of the first lens being concave near the optical axis, and an imaging side surface of the first lens being convex near the optical axis;
a second lens having positive refractive power, an object side surface of the second lens being convex near the optical axis, and an imaging side surface of the second lens being convex near the optical axis;
a third lens having positive refractive power, an object side surface of the third lens being convex near the optical axis, and an imaging side surface of the third lens is convex near the optical axis;
a fourth lens having negative refractive power, an object side surface of the fourth lens being concave near the optical axis, and an imaging side surface of the fourth lens being concave near the optical axis;
a fifth lens having positive refractive power, an object side surface of the fifth lens being convex near the optical axis, and an imaging side surface of the fifth lens is convex near the optical axis;
a sixth lens having negative refractive power, an object side surface of the sixth lens is concave near the optical axis; and
an image plane;
the optical system satisfying following conditional expressions:
$$30 deg < FOV < 45 deg , and 5.2 < TTL / IMGH < 6.8 ;$$
wherein, FOV is the maximum field of view angle of the optical system, TTL is a distance from the object side surface of the first lens to the image plane of the optical system along the optical axis, and IMGH is half of an image height corresponding to the maximum field of view angle of the optical system.

2. The optical system of claim 1, wherein the optical system further satisfies following conditional expression:
$$18 deg \leq FOV / FNO \leq 27 deg ,$$
wherein, FNO is an aperture number of the optical system.

3. The optical system of claim 1, wherein the optical system further satisfies following conditional expression:
$$1.6 \leq FNO \leq 1.8 ,$$
wherein, FNO is an aperture number of the optical system.

4. The optical system of claim 1, wherein the optical system further satisfies following conditional expression:
$$7.9 mm \leq TTL \times IMGH / F \leq 11 mm ;$$
wherein, F is an effective focal length of the optical system.

5. The optical system of claim 1, wherein the optical system further satisfies at least one of following conditional expressions:
$$0.19 \leq ( CT 3 + CT 4 ) / TTL \leq 0.35 , and 0.7 \leq CT 3 / CT 4 \leq 5.1 ;$$
wherein, CT3 is a thickness of the third lens at the optical axis, and CT4 is a thickness of the fourth lens at the optical axis.

6. The optical system of claim 1, wherein the optical system further satisfies following conditional expression:
$$3 \leq ( CT 2 + CT 3 ) / CT 23 \leq 55 ,$$
wherein, CT3 is a thickness of the third lens at the optical axis, CT2 is a thickness of the second lens at the optical axis, and CT23 is a distance from the imaging side surface of the second lens to the object side surface of the third lens at the optical axis.

7. The optical system of claim 1, wherein the optical system further satisfies at least one of following conditional expressions:
$$0.85 \leq SD 1 / IMGH \leq 1.3 , and \\ 0.78 \leq SD 9 / SD 1 \leq 0 \text{.97} ;$$
wherein, SD1 is half of the maximum effective aperture of the object side surface of the first lens, and SD9 is half of the maximum effective aperture of the object side surface of the fifth lens.

8. The optical system of claim 1, wherein the optical system further satisfies following conditional expression:
$$5. 2 \leq TTL / SDL 1 \leq 6.3 ,$$
wherein, SDL1 is the larger of half of the maximum effective aperture of the object side surface of the first lens and half of the maximum effective aperture of the imaging side surface of the first lens.

9. The optical system of claim 1, wherein the optical system further satisfies following conditional expression:
$$0.9 \leq F 3 / F \leq 1.2 ,$$
wherein, F3 is an effective focal length of the third lens, and F is an effective focal length of the optical system.

10. The optical system of claim 1, wherein the optical system further satisfies following conditional expression:
$$- 10 \leq F 4 / CT 4 \leq - 1.5 ,$$
wherein, F4 is an effective focal length of the fourth lens, and CT4 is the thickness of the fourth lens at the optical axis.

11. The optical system of claim 1, wherein the optical system further satisfies following conditional expression:
$$- 1.2 \leq F / F 34 \leq - 0.2 ,$$
wherein, F is an effective focal length of the optical system, and F34 is a combined effective focal length of the third lens and the fourth lens.

12. The optical system of claim 1, wherein the optical system further satisfies following conditional expression:
$$0.67 \leq CT 1 / ET 1 \leq 0.96 ,$$
wherein, CT1 is a thickness of the first lens at the optical axis, and ET1 is an edge thickness of the first lens.

13. The optical system of claim 1, wherein the optical system further satisfies following conditional expression:
$$1.15 \leq CT 2 / ET 2 \leq 1.55 ,$$
wherein, CT2 is a thickness of the second lens at the optical axis, and ET2 is an edge thickness of the second lens.

14. The optical system of claim 1, wherein the optical system further satisfies following conditional expression:
$$- 14 \leq ( F 1 + F 2 ) / F \leq - 1.5 ;$$
wherein, F1 is an effective focal length of the first lens, F2 is an effective focal length of the second lens, and F is an effective focal length of the optical system.

15. The optical system of claim 1, wherein the optical system further satisfies at least one of following conditional expressions:
$$- 2 \text{.5} \leq SAG 11 / CT 6 \leq - 1 , and \\ 7 \leq \vert SAG 11 / SAG 12 \vert \leq 31 ,$$
wherein, SAG11 is a vector height at the maximum effective aperture of the object side surface of the sixth lens, CT6 is a thickness of the sixth lens at the optical axis, and SAG12 is a vector height at the maximum effective aperture of the imaging side surface of the sixth len.

16. The optical system of claim 1, wherein the optical system further satisfies following conditional expression:
$$0.25 \leq CT 6 / ET 6 \leq 0.55 ;$$
wherein, CT6 is a thickness of the sixth lens at the optical axis, and ET6 is an edge thickness of the sixth lens.

17. The optical system of claim 1, wherein the optical system further satisfies following conditional expression:
$$1.1 \leq \vert ( R 3 - R 4 ) / ( R 3 + R 4 ) \vert \leq 6.3 ,$$
wherein, R3 is a radius of curvature of the object side surface of the second lens at the optical axis, and R4 is a radius of curvature of the imaging side surface of the second lens at the optical axis.

18. The optical system of claim 1, wherein the optical system further satisfies at least one of following conditional expressions:
$$8 \leq \vert R 12 / R 11 \vert \leq 31 , and \\ 4.5 \leq \vert R 12 / F \vert \leq 19 ;$$
wherein, R11 is a radius of curvature of the object side surface of the sixth lens at the optical axis, R12 is a radius of curvature of the imaging side surface of the sixth lens at the optical axis, and F is an effective focal length of the optical system.

19. An image module comprising:
a photosensitive chip; and
an optical system, from an object side to an imaging side along an optical axis, sequentially comprising:
a first lens having negative refractive power, an object side surface of the first lens being convex near the optical axis, and an imaging side surface of the first lens being convex near the optical axis;
a second lens having positive refractive power, an object side surface of the second lens being convex near the optical axis, and an imaging side surface of the second lens being convex near the optical axis;
a third lens having positive refractive power, an object side surface of the third lens being convex near the optical axis, and an imaging side surface of the third lens is convex near the optical axis;
a fourth lens having negative refractive power, an object side surface of the fourth lens being concave near the optical axis, an imaging side surface of the fourth lens being concave near the optical axis;
a fifth lens having positive refractive power, an object side surface of the fifth lens being convex near the optical axis, and an imaging side surface of the fifth lens is convex near the optical axis;
a sixth lens having negative refractive power, an object side surface of the sixth lens is concave near the optical axis; and
an image plane;
the optical system satisfying following conditional expressions:
$$30 deg < FOV < 45 deg , and 5.2 < TTL / IMGH < 6.8 ;$$
wherein, FOV is the maximum field of view angle of the optical system, TTL is a distance from the object side surface of the first lens to the image plane of the optical system along the optical axis, and IMGH is half of an image height corresponding to the maximum field of view angle of the optical system.

20. An electronic device comprising:
a housing; and
an image module arranged in the housing and comprising:
a photosensitive chip; and
an optical system, from an object side to an imaging side along an optical axis, sequentially comprising:
a first lens having negative refractive power, an object side surface of the first lens being convex near the optical axis, and an imaging side surface of the first lens being convex near the optical axis;
a second lens having positive refractive power, an object side surface of the second lens being convex near the optical axis, and an imaging side surface of the second lens being convex near the optical axis;
a third lens having positive refractive power, an object side surface of the third lens being convex near the optical axis, and an imaging side surface of the third lens is convex near the optical axis;
a fourth lens having negative refractive power, an object side surface of the fourth lens being concave near the optical axis, an imaging side surface of the fourth lens being concave near the optical axis;
a fifth lens having positive refractive power, an object side surface of the fifth lens being convex near the optical axis, and an imaging side surface of the fifth lens is convex near the optical axis;
a sixth lens having negative refractive power, an object side surface of the sixth lens is concave near the optical axis; and
an image plane;
the optical system satisfying following conditional expression:
$$30 deg < FOV < 45 deg , and 5.2 < TTL / IMGH < 6.8 ;$$
wherein, FOV is the maximum field of view angle of the optical system, TTL is a distance from the object side surface of the first lens to the image plane of the optical system along the optical axis, and IMGH is half of an image height corresponding to the maximum field of view angle of the optical system.
